(19) United States
(12) Patent Application Publication
(10) Pub. No.: US 2023/0135709 A1
(43) Pub. Date: May 4, 2023

(54) INFORMATION PROCESSING DEVICE AND INFORMATION PROCESSING METHOD

(71) Applicant: SONY GROUP CORPORATION, TOKYO (JP)

(72) Inventors: OSAMU ITO, TOKYO (JP); RYO YOKOYAMA, TOKYO (JP); IKUO YAMANO, TOKYO (JP)

(21) Appl. No.: 17/907,698

(22) PCT Filed: Mar. 18, 2021
(86) PCT No.: PCT/JP2021/011226

§ 371 Date: Sep. 29, 2022

(30) Foreign Application Priority Data
Apr. 14, 2020 (JP) 2020-072424

(51) Int. Cl. G06F 3/04847

(52) U.S. Cl. CPC G06F 3/04847; G06F 2203/04803

(57) ABSTRACT

An information processing device includes a user interface processing unit that performs user interface processing for creating data for tactile presentation, the user interface processing including: displaying a first display area on which a first operation of specifying time-series information about the data is allowed; detecting the first operation; displaying a second display area in which the time-series information specified according to the first operation is displayed; and detecting a change operation for the time-series information as a second operation on the second display area.

### TECHNICAL FIELD

The present technology relates to an information processing device and an information processing method, and particularly to a technology related to an information processing device that assists in the creation of data for tactile presentation.

### BACKGROUND ART

A technology has been proposed that allows a user to experience various stimuli as well as video and sound to provide a user experience with a sense of reality. For example, PTL 1 referred to below discloses a technology that allows a user who wears a vest-type device provided with a plurality of vibration units to experience a tactile stimulus that is given in time with video and sound and thus to enhance a sense of reality.

### CITATION LIST

### Patent Literature

### [PTL 1]

JP 2018-45270 A

### SUMMARY

### Technical Problem

In order to experience such a tactile stimulus, it is necessary to create a tactile signal to be supplied to the above-mentioned vest-type device or the like that presents the tactile stimulus. However, it cannot be said that the environment for creating such a tactile signal is sufficiently prepared.

The present technology has been made in view of such circumstances, and aims to provide an environment that facilitates the creation of data for any tactile presentation.

### Solution to Problem

An information processing device according to the present technology includes a user interface processing unit that performs user interface processing for creating data for tactile presentation, the user interface processing including: displaying a first display area on which a first operation of specifying time-series information about the data is allowed; detecting the first operation; displaying a second display area in which the time-series information specified according to the first operation is displayed; and detecting a change operation for the time-series information as a second operation on the second display area.

This makes it possible to create time-series information about tactile data and to visually confirm the time-series information.

In the above-described information processing device, the first operation may be an operation of specifying time-series information of a presentation target position of the tactile presentation.

This makes it possible to create the time-series information about the presentation target position of a tactile stimulus according to the tactile data.

In the above-described information processing device, the time-series information of the presentation target position may be specified by moving a pointer on the first display area.

This makes it possible to easily specify the presentation target position of a tactile stimulus according to the tactile data by using a pointer device such as a mouse.

In the above-described information processing device, the first operation may allow for specifying a presentation period in which the tactile presentation is to be performed and a non-presentation period in which the tactile presentation is not to be performed.

This makes it possible to create intermittent tactile data.

The user interface processing unit of the above-described information processing device may perform processing of displaying position information of a presentation device that performs the tactile presentation in the first display area.

This makes it possible to create tactile data based on the position of the presentation device.

The user interface processing unit of the above-described information processing device may display an operating range centered around the presentation target position in the first display area.

This makes it possible to create tactile data while being aware of not only the position of the presentation device but also the operating range according to the tactile data.

The user interface processing unit of the above-described information processing device may perform display processing of displaying a preview of the data in the first display area.

This makes it possible to visually confirm the created tactile data.

The user interface processing unit of the information processing device may perform processing of detecting an operation of switching between a mode in which the change operation is enabled and a mode in which the change operation is disabled.

This makes it possible to confirm the created tactile data along the time axis and to perform a modification operation on the tactile data.

In the above-described information processing device, the second operation may be a change operation for time-series information of the presentation target position.

This makes it possible to perform an operation of adjusting the presentation target position of a tactile stimulus according to the created tactile data.

In the above-described information processing device, the second operation may be a change operation for time-series information of the operating range.

This makes it possible to change to a wide range or a narrow range a stimulus experienced by the user when the tactile data is reproduced.

The user interface processing unit of the above-described information processing device may display the second display area so that the presentation period and the non-presentation period are distinguishable from each other.

This makes it possible to specifically grasp in time series the presence or absence of a stimulus experienced by the user when the tactile data is reproduced.

The user interface processing unit of the above-described information processing device may display a presentation intensity of the tactile presentation in the second display area.

This makes it possible to change the intensity of a stimulus experienced by the user when the tactile data is reproduced.

The user interface processing unit of the above-described information processing device may display an operation pattern of a presentation device for each presentation period in the second display area.

This makes it possible to grasp what kind of operation pattern is executed in the presentation device during the presentation period.

In the above-described information processing device, the second operation may be a change operation for the operation pattern.

This makes it possible to change, for example, a vibration pattern as an operation pattern of the presentation device for each presentation period.

In the above-described information processing device, the second operation may be an operation of moving the time-series information to be changed in time direction.

This makes it possible to modify, when the start timing of a presentation period of tactile data deviates from video and sound, the tactile data without recreating the tactile data.

An information processing method according to the present technology is performed by an information processing device and includes: displaying a first display area on which a first operation of specifying time-series information of data created for tactile presentation is allowed; detecting the first operation; displaying a second display area in which the time-series information specified according to the first operation is displayed; and detecting a change operation for the time-series information as a second operation on the second display area.

### BRIEF DESCRIPTION OF DRAWINGS

FIG. 1 is a diagram illustrating a configuration example of a tactile data creation system.

FIG. 2 is a diagram illustrating a configuration example of a cinema system and a provision system.

FIG. 3 is a block diagram of an information processing device.

FIG. 4 is a functional block diagram of a tactile data creation device.

FIG. 5 is a functional block diagram of a tactile presentation control device.

FIG. 6 is an example of a start screen.

FIG. 7 is an example of a setting screen.

FIG. 8 is an example of an adjustment screen, illustrating a state immediately after startup.

FIG. 9 is a display example of a coordinate area in a circle mode.

FIG. 10 is a diagram illustrating that one ventral output part icon in the coordinate area in the circle mode has changed from a state of being outside the region to a state of being in an attenuation region.

FIG. 11 is a diagram illustrating that, following FIG. 10, the ventral output part icon has changed from the state of being in the attenuation region to a state of being in a non-attenuation region.

FIG. 12 is a diagram illustrating that, following FIG. 11, the ventral output part icon has changed from a state of being in the non-attenuation region to a state of being in the attenuation region.

FIG. 13 is a diagram illustrating that, following FIG. 12, the ventral output part icon has changed from a state of being in the non-attenuation region to a state of being outside the region.

FIG. 14 is a display example of a coordinate area in a triangle mode when tactile data on the front side is created.

FIG. 15 is a display example of a coordinate area in the triangle mode when tactile data on the back side is created.

FIG. 16 is an example of the non-attenuation region and the attenuation region.

FIG. 17 is a display example of a circle shape specification part.

FIG. 18 is a display example of the circle shape specification part when a first control is operated from the state illustrated in FIG. 17.

FIG. 19 is a diagram illustrating the non-attenuation region and the attenuation region which are specified by the circle shape specification part illustrated in FIG. 18.

FIG. 20 is a display example of the circle shape specification part when a second control is operated from the state illustrated in FIG. 17.

FIG. 21 is a diagram illustrating the non-attenuation region and the attenuation region which are specified by the circle shape specification part illustrated in FIG. 20.

FIG. 22 is a diagram illustrating an initial state of a creation screen 102 when tactile data is created.

FIG. 23 is a diagram illustrating a state in which tactile data is created following FIG. 22.

FIG. 24 is a diagram illustrating a state in which tactile data is created following FIG. 23, and is also a diagram illustrating a state in which a vibration period is specified.

FIG. 25 is a diagram illustrating a state in which tactile data is created following FIG. 24, and is also a diagram illustrating a state in which a drag operation is performed on a presentation target position pointer.

FIG. 26 is a diagram illustrating a state in which tactile data is created following FIG. 25, and is also a diagram illustrating a state in which the specification of the vibration period is canceled.

FIG. 27 is a diagram illustrating a state in which tactile data is created following FIG. 26, and is also a diagram illustrating a state in which the vibration period is specified again.

FIG. 28 is a diagram illustrating a state in which tactile data has been created, following FIG. 27.

FIG. 29 is a diagram illustrating a state in which the tactile data is modified in a TOUCH mode, following FIG. 28.

FIG. 30 is a diagram illustrating a state in which the tactile data is modified in the TOUCH mode, following FIG. 29.

FIG. 31 is a diagram illustrating a state in which the tactile data is being modified in the TOUCH mode following FIG. 30, and is a diagram illustrating a state in which a part of the tactile data is overwritten by a modification operation.

FIG. 32 is a diagram for explaining how time-series data is modified by a modification operation on the tactile data, and is also a diagram illustrating a state before the modification.

FIG. 33 is a diagram for explaining how the time-series data is modified by the modification operation on the tactile data together with reference to FIG. 32, and is also a diagram illustrating a state in which a part of the time-series data has been modified by a drag operation.

FIG. 34 is a diagram for explaining how the time-series data is modified by the modification operation on the tactile data together with FIG. 32, and is also a diagram illustrating a state in which a part of information displayed in a library information display area has been modified.

FIG. 35 is a diagram for explaining how the time-series data is modified by the modification operation on the tactile data together with reference to FIG. 32, and is also a diagram illustrating a state in which the width and height of a part of note-on areas have been modified.

FIG. 36 is a diagram for explaining how the time-series data is modified by the modification operation on the tactile data together with reference to FIG. 32, and is also a diagram illustrating a state in which a part of the note-on areas has been modified by dragging in the time direction.

FIG. 37 is an example of an adjustment screen.

### DESCRIPTION OF EMBODIMENTS

Hereinafter, an embodiment will be described in the following order.

<1. System configuration>
<1-1. Tactile data creation system>
<1-2. Cinema system and provision system>
<1-3. Provision system>
<2. Configuration of information processing device>
<3. UI screen>
<3-1. Start screen>
<3-2. Setting screen>
<3-3. Creation screen>
(Channel display region 140)
(Position region 141)
(Operation setting region 142)
(Note region 143)
(Channel region 144)
(Timeline region 145)
<4. Operation example>
<4-1. Creation operation on tactile data>
<4-2. Reproduction operation on tactile data>
<4-3. Modification operation on tactile data>
<5. UI screen in tactile presentation control device>

### <6. Conclusion>

<7. Present technology>

### 1. System Configuration

In the present embodiment, a tactile data creation system will be described including a tactile data creation device that involves the creation of data (tactile data) for tactile presentation. In addition, a system will be described providing a tactile stimulus to a user based on the created tactile data.

In the following description, an example of providing a tactile stimulus to a user in order to further enhance a sense of reality of a movie content will be taken, but the implementation of the present technology is not limited to this. For example, it may provide a new experience to the user by a combination of acoustic data, such as music and voice, and a tactile stimulus. Further, it may make a game more enjoyable by providing a tactile stimulus in time with video data and acoustic data contained in the game content. Of course, a combination of information other than video data and acoustic data and a tactile stimulus may be provided to the user.

### <1-1. Tactile Data Creation System>

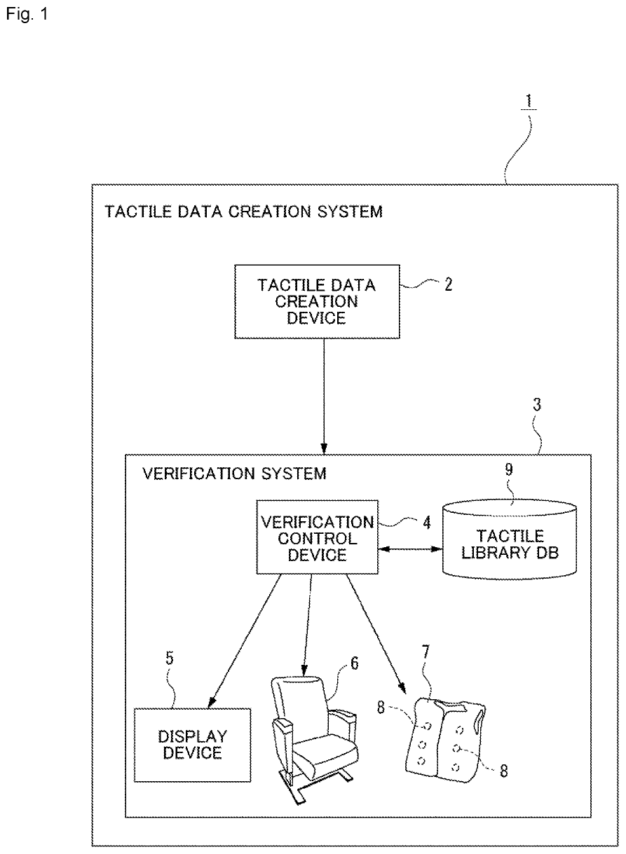

A tactile data creation system 1 will be described with reference to FIG. 1.

The tactile data creation system 1 includes a tactile data creation device 2 and a verification system 3.

The tactile data creation device 2 is a device in which software described later used by an operator who makes (creates) tactile data is installed, and is an information processing device such as a personal computer (PC) or a tablet terminal. The tactile data creation device 2 executes various types of user interface processing via software. Such user interface processing makes it possible for an operator to easily create tactile data. Such user interface processing will be described later.

The verification system 3 is used by the operator himself/herself to experience and confirm the tactile presentation according to the created tactile data. The verification system 3 includes, for example, a verification control device 4, a display device 5, a seat-type presentation device 6, and a tactile presentation device 7.

The verification control device 4 is an information processing device that performs various types of processing for the operator himself/herself to experience the content to be experienced by a user in a movie theater.

Specifically, the verification control device 4 transmits video data and acoustic data as the movie content to the display device 5.

The verification control device 4 transmits data for providing a stimulus to the operator in time with the video data and the acoustic data which are output by the display device 5 to the seat-type presentation device 6. The provision of the stimulus to the operator is performed by, for example, emitting a scent, air or water, or generating vibration or heat. The posture of the operator may be changed in synchronization with an actual scene of the movie by tilting the seat-type presentation device 6.

In addition, the verification control device 4 transmits the tactile data (details will be described later) created by the operator to the tactile presentation device 7.

The display device 5 is, for example, a monitor device provided with an acoustic output unit, and can display video data and reproduce acoustic data.

The seat-type presentation device 6 presents (provides) a stimulus to the operator by emitting a scent, air, or the like based on the control of the verification control device 4.

The tactile presentation device 7 is a device that generates vibration or the like based on the tactile data created by the operator.

The tactile presentation device 7 has a shape, such as a vest shape, which can be worn by the operator, and includes a plurality of presentation units 8.

Each presentation unit 8 is configured to be vibrated by, for example, an actuator provided therein, and can be driven based on a tactile signal created based on the tactile data to transmit a tactile stimulus to the operator.

Of the plurality of presentation units 8 included in the tactile presentation device 7, for example, six presentation units 8 are located on the front side (ventral side) of the wearer operator, and four presentation units 8 are located on the back side. FIG. 1 illustrates the six presentation units 8 arranged on the front side.

The tactile presentation device 7 includes, for example, a reception unit that receives tactile data created by the tactile data creation device 2 from the verification control device 4 through wireless communication, and outputs a tactile signal (drive signal) corresponding to the received tactile data to the respective presentation units 8.

The tactile data includes, for example, control information associated with a time code to synchronize with a content to be reproduced. Specifically, the tactile data includes information for identifying the time code and the presentation unit 8 to be driven, information for identifying an operation pattern, information on a presentation intensity of the tactile signal, and the like.

It is necessary to synchronize various types of information transmitted by the verification control device 4 to the display device 5, the seat-type presentation device 6, and the tactile presentation device 7 in order to enhance a sense of reality of the movie content. To this end, the verification control device 4 manages the time code.

The display device 5, the seat-type presentation device 6, and the tactile presentation device 7 can provide an effective user experience by performing various types of outputs according to the time code received from the verification control device 4. This allows the operator to effectively verify the tactile data created confidently.

The verification control device 4 manages a tactile library DB (Database) 9 in which operation patterns (vibration patterns) of the presentation units 8 of the tactile presentation device 7 are stored as a tactile library.

### <1-2. Cinema System and Provision System>

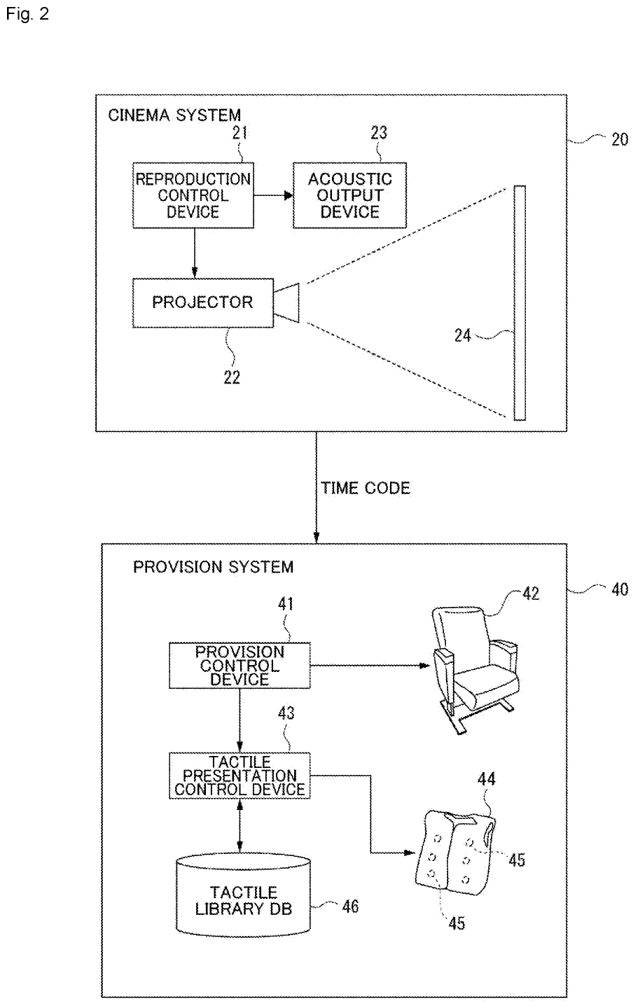

The configuration of a cinema system 20 that provides a movie content to a user and a provision system 40 that provides a tactile stimulus based on the tactile data created by the tactile data creation system 1 to the user will be described with reference to FIG. 2.

The cinema system 20 includes a reproduction control device 21, a projector 22, an acoustic output device 23, and a screen 24.

The reproduction control device 21 outputs the video data of a movie content to the projector 22 and outputs the acoustic data to the acoustic output device 23. The reproduction control device 21 transmits a time code indicating the reproduction position of a video content to the provision system 40 to synchronize the cinema system 20 with the provision system 40 described later.

The projector 22 displays a video on the screen 24 by performing projection processing on the video data of the movie content based on an instruction from the reproduction control device 21.

The acoustic output device 23 performs sound output synchronized with the video content based on an instruction from the reproduction control device 21.

### <1-3. Provision System>

The provision system 40 includes a provision control device 41, a seat-type presentation device 42, a tactile presentation control device 43, and a tactile presentation device 44.

The provision control device 41 receives a time code from the cinema system 20 and controls each device based on the time code. Specifically, the provision control device 41 outputs various types of drive instructions to the seat-type presentation device 42 according to the time code.

The seat-type presentation device 42 performs operations such as emitting a scent, air, and water in the same manner as the seat-type presentation device 6 in response to an instruction from the provision control device 41.

The provision control device 41 transmits the tactile data and the like together with the time code to the tactile presentation control device 43 to execute a predetermined operation.

The tactile presentation control device 43 transmits a tactile signal to the tactile presentation device 44 at an appropriate timing according to the time code and the tactile data received from the provision control device 41.

The tactile presentation device 44 includes presentation units 45 and a reception unit that receives a tactile signal through wireless communication, as with the tactile presentation device 7 included in the verification system 3.

The tactile presentation device 44 provides a tactile stimulus to the user by outputting the received tactile signal to an appropriate presentation unit 45. For example, a number of tactile presentation devices 44 are prepared for the seating capacity of a movie theater.

The tactile presentation control device 43 manages a tactile library DB 46 in which a tactile library is stored. The information of the tactile library stored in the tactile library DB 46 is the same as that of the tactile library DB 9.

### 2. Configuration of Information Processing Device

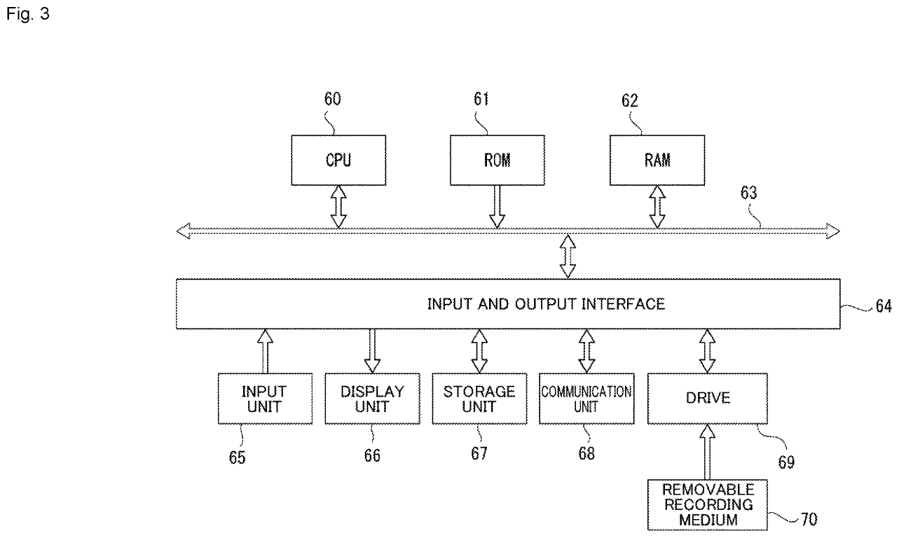

The configurations of the tactile data creation device 2 and the verification control device 4 of the verification system 3, which are included in the tactile data creation system 1, the reproduction control device 21, which is included in the cinema system 20, the provision control device 41 and the tactile presentation control device 43, which are included in the provision system 40 will be described with reference to FIG. 3.

Each of these devices includes an information processing device having an arithmetic processing function, such as a general-purpose personal computer, a terminal device, a tablet terminal, or a smartphone.

A CPU 60 of the information processing device executes various types of processing according to a program stored in a ROM 61 or a program loaded from a storage unit 67 into a RAM 62. The RAM 62 also stores data and the like necessary for the CPU 60 to execute various types of processing as appropriate. The CPU 60, the ROM 61, and the RAM 62 are connected to each other via a bus 63. An input and output interface 64 is also connected to the bus 63.

An input unit 65 including a control or an operation device is connected to the input and output interface 64.

For example, various types of controls or operation devices such as a keyboard, a mouse, keys, a dial, a touch panel, a touch pad, and a remote controller are assumed as the input unit 65. Alternatively, voice input or the like may be possible.

An operator's operation is detected by the input unit 65 and a signal corresponding to an input operation is interpreted by the CPU 60.

A display unit 66 including an LCD, an organic EL panel, or the like is connected integrally or separately to the input and output interface 64.

The display unit 66 is a display unit that performs various types of displays, and is configured of, for example, a display device provided in the housing of the information processing device, or, for example, a separate display device connected to the information processing device.

The display unit 66 executes the display of various types of user interface (UI) screens, a movie content of video, and the like on a display screen based on an instruction from the CPU 60. On the UI screen(s), various types of operation menus, icons, messages, and the like are displayed based on an instruction from the CPU 60.

The storage unit 67 configured of a hard disk, a solid-state memory, or the like, or a communication unit 68 configured of a modem or the like are connected to the input and output interface 64.

The communication unit 68 performs communication processing via a transmission path such as the Internet and communication such as wired/wireless communication or bus communication with various types of devices.

In the case of the present embodiment, the communication unit 68 of the tactile data creation device 2 transmits the created tactile data to the verification system 3. The communication unit 68 of the reproduction control device 21 transmits the time code to the provision system 40.

A drive 69 is also connected to the input and output interface 64 as necessary, and a removable recording medium 70 such as a magnetic disk, an optical disc, a magneto-optical disc, or a semiconductor memory is mounted in the drive 69 as appropriate.

The drive 69 makes it possible to read a data file such as an image file, various types of computer programs, or the like from the removable recording medium 70. The read data file is stored in the storage unit 67 or an image or a sound included in the data file is output to the display unit 66. A computer program or the like read from the removable recording medium 70 is installed in the storage unit 67 as necessary.

In the information processing device, for example, software for processing in the present disclosure can be installed through network communication using the communication unit 68 or via the removable recording medium 70.

Alternatively, the software may be stored in advance in the ROM 61, the storage unit 67, or the like.

For example, such software constructs a configuration for implementing various types of functions in the CPU 60 of each information processing device.

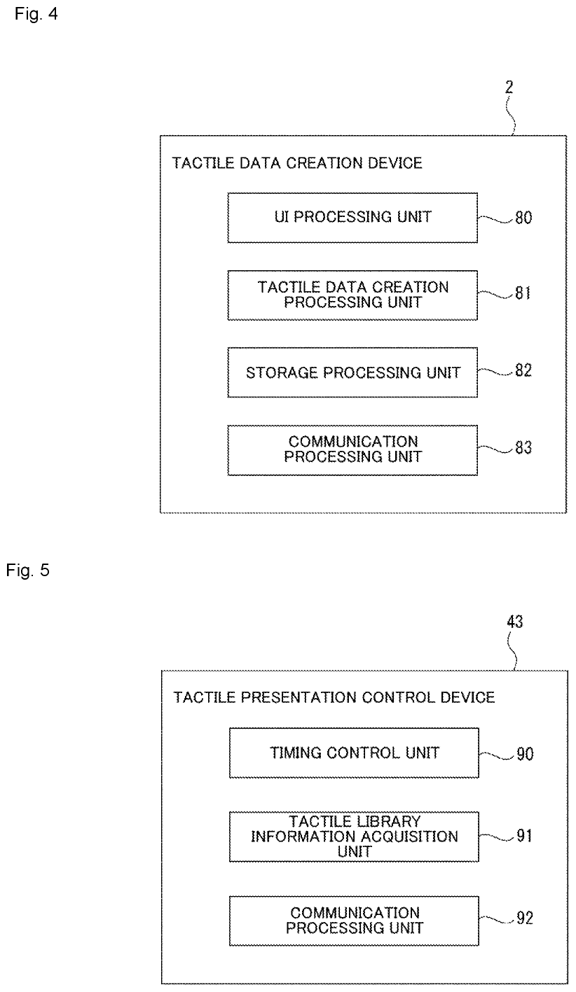

Specifically, the CPU 60 of the tactile data creation device 2 constructs functions as a UI processing unit 80, a tactile data creation processing unit 81, a storage processing unit 82, and a communication processing unit 83 (see FIG. 4).

The CPU 60 of the tactile presentation control device 43 constructs functions as a timing control unit 90, a tactile library information acquisition unit 91, and a communication processing unit 92 (see FIG. 5).

These functions will be described with reference to FIGS. 4 and 5.

The UI processing unit 80 of the tactile data creation device 2 performs various types of UI processing described later. Specifically, processing of displaying a UI screen for using software for creating tactile data on the display unit 66, processing of detecting a mouse operation or a touch operation as an operation on the input unit 65, display processing according to such an operation, and the like are performed. Specifically, they will be described later with reference to figures illustrating UI screens.

The tactile data creation processing unit 81 creates tactile data according to an operator's operation on a UI screen. As described above, the tactile data includes information such as the timing for providing a tactile stimulus to the user, information for identifying the presentation unit 8 (presentation unit 45) to be driven, an operation pattern, and output intensity for each presentation unit 8.

The storage processing unit 82 performs processing such as storing the created tactile data in the storage unit 67.

The communication processing unit 83 performs processing such as transmitting the tactile data by using the communication unit 68.

The timing control unit 90 of the tactile presentation control device 43 manages the timing at which a tactile signal is to be transmitted to the tactile presentation device 44 according to a time code received from the cinema system 20.

The tactile library information acquisition unit 91 acquires waveform information indicating an operation pattern of the presentation unit 45 from the tactile library DB 46 based on the tactile data.

The communication processing unit 92 performs processing of transmitting a tactile signal to the tactile presentation device 44, processing of acquiring information from the tactile library DB 46, and the like.

### 3. UI Screen

Examples of UI screens displayed on the display unit 66 by the UI processing executed by the tactile data creation device 2 of the tactile data creation system 1 will be described with reference to the attached drawings. Each UI screen is provided to the operator when software installed in the tactile data creation device 2 to assist in the creation of the tactile data is executed. Hereinafter, this software is simply referred to as “software”.

In addition, any type of data format may be used for the tactile data created by the software. In the following description, a case where tactile data is formed as Musical Instrument Digital Interface (MIDI) format data will be described as an example.

### <3-1. Start Screen>

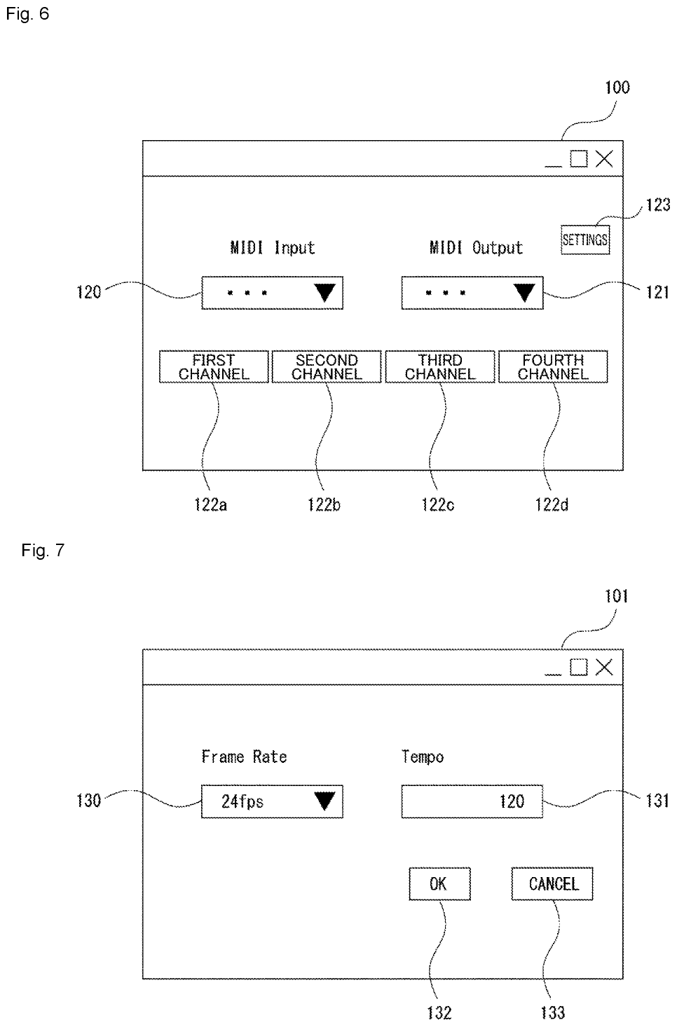

When the software is started, a start screen 100 illustrated in FIG. 6 is displayed. The start screen 100 includes a reception port selection part 120 serving as a control for selecting a reception port for MIDI data, a transmission port selection part 121 serving as a control for selecting a transmission port for MIDI data, a plurality of channel buttons 122, 122, . . . , and a setting button 123.

By selecting any port in the tactile data creation device 2 in the reception port selection part 120, MIDI data can be imported into the software via the selected port.

By selecting any port in the tactile data creation device 2 in the transmission port selection part 121, MIDI data can be output from the software via the selected port.

The channel buttons 122 are controls for creating tactile data for the respective channels. As examples of the channel button 122, a first channel button 122a for starting a tactile data creation screen for a first channel, a second channel button 122b for starting a tactile data creation screen for a second channel, a third channel button 122c for starting a tactile data creation screen for a third channel, and a fourth channel button 122d for starting a tactile data creation screen for a fourth channel are arranged.

For example, when the first channel button 122a is pressed, tactile data is created for providing the user with a tactile stimulus corresponding to a gun shot; when the second channel button 122b is pressed, tactile data is created for providing the user with an impact on the back felt when falling down as a tactile stimulus.

When the tactile stimulus is provided to the user, the presentation units 8 or 45 are driven based on both the tactile data created by the first channel button 122a and the tactile data created by the second channel button 122b, so that it is possible to provide the user with tactile stimuli that imitates impacts of a gun shot and then falling on the back to the ground.

In this way, by using the plurality of channel buttons 122 properly to create tactile data, complicated tactile data can be easily created.

The setting button 123 is a control for making settings for synchronizing video data and acoustic data with the tactile data.

When the setting button 123 is pressed, a setting screen 101 illustrated in FIG. 7 is displayed.

### <3-2. Setting Screen>

On the setting screen 101, a frame rate selection part 130 serving as a control for setting a frame rate, a tempo selection part 131 serving as a control for selecting a tempo, an OK button 132, and a cancel button 133 are arranged.

In the present example, for example, the tactile data is issued according to a frame rate, and accordingly, the frame rate set on the setting screen 101 is matched with the frame rate for tactile presentation using the tactile data with the presentation device (tactile presentation control device 43), so that it is possible to perform tactile presentation based on the tactile data at the intended timing.

Further, in the present example, the created tactile data is MIDI data, and accordingly, time management is performed on the tactile data by using a tempo and a bar. Therefore, by matching the tempo in creating tactile data with the tempo in performing tactile presentation based on the tactile data in the presentation device, the tactile presentation can be performed at the intended timing.

When the OK button 132 is pressed, the selected frame rate and the selected tempo are determined. Accordingly, tactile data is created based on the selected frame rate and the selected tempo.

When the cancel button 133 is pressed, the selected frame rate and the selected tempo are canceled, the display of the setting screen 101 ends, and then the start screen 100 is displayed.

### <3-3. Creation Screen>

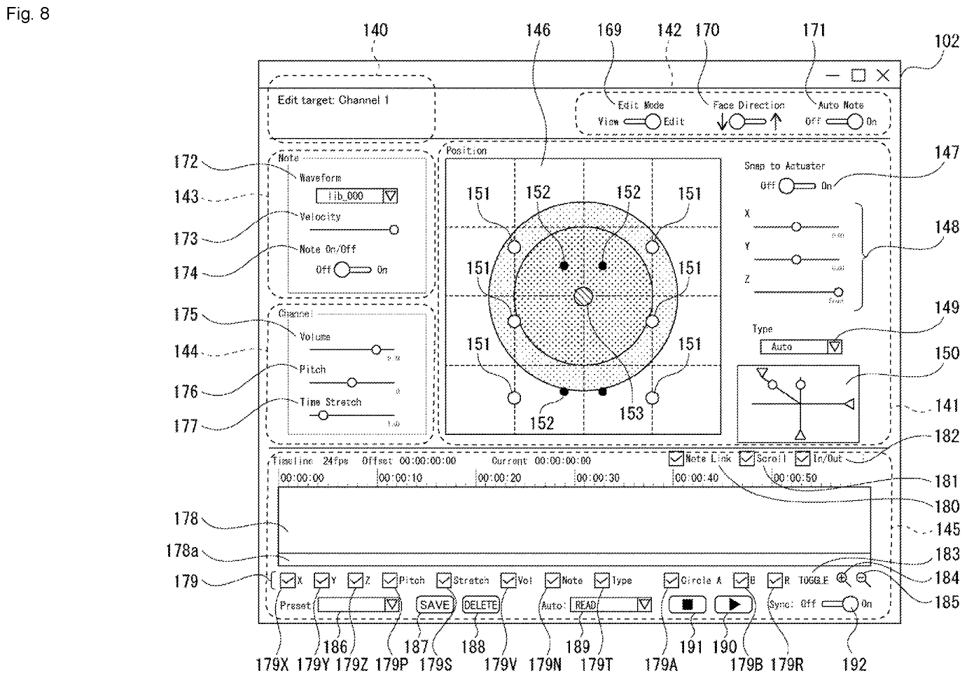

FIG. 8 illustrates an example of the creation screen 102 displayed when the channel button 122 is pressed. The creation screen 102 is a UI screen for creating tactile data for the channel selected on the start screen 100.

Various types of regions are provided on the creation screen 102, and for the respective regions, various types of controls and display regions are arranged. Specifically, on the creation screen 102, a channel display region 140, a position region 141, an operation setting region 142, a note region 143, a channel region 144, and a timeline region 145 are arranged.

### (Channel Display Region 140)

In the channel display region 140, information indicating the channel to be created is displayed. In the example illustrated in FIG. 8, “Channel 1” is to be created. In other words, the example indicates a case where the first channel button 122a of FIG. 6 is pressed.

### (Position Region 141)

In the position region 141, a coordinate area 146, a snap setting part 147, a coordinate slider 148, a type setting part 149, and a circle shape specification part 150 are arranged.

The coordinate area 146 is a region in which the relative positional relationship between the position of the presentation unit 8 (presentation unit 45) provided in the tactile presentation device 7 (tactile presentation device 44) and the central position of the tactile stimulus (presentation target position) is displayed. The horizontal axis of the coordinate area 146 is the X axis, and the vertical axis is the Y axis.

In the coordinate area 146, a range of −1 to +1 on the X-axis and a range of −1 to +1 on the Y-axis are displayed. The center of the coordinate area 146 is the origin where both the X-axis and the Y-axis are set to 0.

In the coordinate area 146, the coordinate positions of the presentation units 8 or 45 are displayed. Specifically, the positions of six presentation units 8 or 45 located on the front side (ventral side) of the operator in the state where the operator wears the vest-type tactile presentation device 7 or 44 are indicated by white circles as ventral output part icons 151; four presentation units 8 or 45 located on the back side (dorsal side) of the operator are indicated by black circles as back output part icons 152.

In the following description, the operator or user who wears the vest-type tactile presentation device 7 or 44 is simply referred to as a “wearer”.

In the coordinate area 146, a presentation target position pointer 153 (indicated by diagonal hatching in the figure) indicating the center position of the tactile stimulus is illustrated.

The function of the coordinate area 146 differs depending on the mode. The creation screen 102 has two modes, one is “edit mode” and the other is “view mode”.

The “edit mode” is a mode in which tactile data is created by specifying in the position region 141 a locus of the presentation target position of a tactile stimulus, that is, of the position where a tactile stimulus is generated in the vest-type tactile presentation device 7 or 44. The tactile data can be created by selecting any mode in a mode selection part described later.

The “view mode” is a mode in which the locus of the presentation target position in the created tactile data is reproduced in the position region 141.

In the edit mode, it is possible to specify a period during which the presentation unit(s) 8 or 45 are vibrated and a period during which the presentation unit(s) 8 or 45 are not vibrated. The period during which any of the presentation units 8 or 45 is vibrated is defined as a “vibration period”, and the period during which none of the presentation units 8 or 45 is vibrated is defined as a “non-vibration period”.

The “vibration period” may be referred to as a “note”.

In the coordinate area 146, a circular region centered around the presentation target position pointer 153 is displayed. The circular region indicates the range of a tactile stimulus.

Specifically, the circular region is composed of a “non-attenuation region” in which the intensity of the tactile stimulus is not attenuated and an “attenuation region” in which the intensity of the tactile stimulus is attenuated. The non-attenuation region and the attenuation region will be described later.

In the edit mode and the view mode, the display mode of the presentation target position pointer 153 may be changed between the vibration period and the non-vibration period.

In the “edit mode” being selected, a locus of the center position of the tactile stimulus to be presented to the wearer in the coordinate area 146 is allowed to be specified. As a result, time-series data of the X-coordinate and the Y-coordinate of the presentation target position of the tactile stimulus corresponding to the specified locus is created.

On the other hand, in the “view mode” being selected, a locus of the presentation target position in the created tactile data can be reproduced in the coordinate area 146.

The snap setting part 147 is a control for setting whether or not to snap the presentation target position pointer 153 to the coordinates of each output part. In the snap setting part 147, “On setting” for snapping the presentation target position pointer 153 to the coordinates of each output unit or “Off setting” for not snapping can be selected. In the “On” setting, the presentation target position pointer 153 is not allowed to be located at coordinates other than the coordinates of the output units, and is located at the coordinates of the nearest output unit.

The coordinate slider 148 indicates the position of the presentation target position pointer 153. Specifically, in the example illustrated in FIG. 8, the presentation target position pointer 153 is located at the center position of the coordinate area 146, and the X coordinate and the Y coordinate are both set to “0” in the coordinate slider 148. The coordinate slider 148 also displays the Z coordinate position. The Z coordinate indicates the position of the wearer's body in the thickness direction. In FIG. 8, either “Back” indicating the back side or “Front” indicating the front side can be selected. For the Z coordinate, for example, “0” which represents the center in the thickness direction of the body, “0.5”, and “−0.5” may be set where the dorsal surface and the ventral surface are set to “−1” and “+1”, respectively. For example, by vibrating both the presentation units 8 or 45 located on the front side and the presentation units 8 or 45 located on the back side, a tactile stimulus can be provided as if the wearer felt a stimulus at the center (the position of the Z coordinate “0”) of the body. This is based on the fact that when tactile stimuli are given to a plurality of places on the human body, the person perceives the stimuli as being given to parts between the plurality of places.

The type setting part 149 is a control for changing an algorithm for determining the presentation units 8 or 45 to be operated. Specifically, the algorithm is changed by switching between “circle mode” and “triangle mode”. “Auto mode” may be provided in which the mode is automatically switched between the “circle mode” and the “triangle mode”.

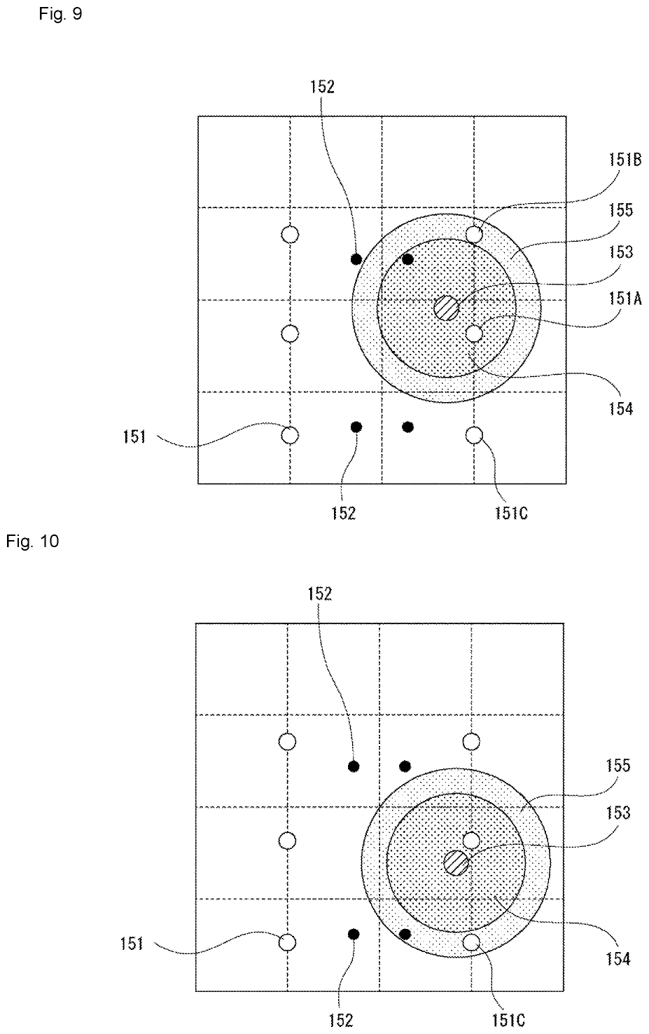

First, the “circle mode” will be described with reference to FIG. 9.

In the “circle mode”, an algorithm is adopted for determining the presentation units 8 or 45 to be operated by the circular region centered around the presentation target position pointer 153. In the following, tactile data for giving a tactile stimulus to the wearer on the front side will be taken as an example.

In the vibration period, the presentation units 8 or 45 are vibrated corresponding to the ventral output part icons 151 located in a non-attenuation region 154 set on the outer peripheral side of the presentation target position pointer 153 and an attenuation region 155 set on the further outer peripheral side of the non-attenuation region 154.

In the example illustrated in FIG. 9, one ventral output part icon 151A is included in the non-attenuation region 154. One ventral output part icon 151B is included in the attenuation region 155.

The presentation units 8 or 45 corresponding to the ventral output part icons 151 included in the non-attenuation region 154 generate vibration with a set predetermined intensity. The presentation units 8 or 45 corresponding to the ventral output part icons 151 included in the attenuation region 155 generate vibration with an intensity attenuated with respect to the set predetermined intensity according to the distance from the outer edge of the non-attenuation region 154.

In other words, the ventral output part icon 151A vibrates at a set predetermined intensity while the ventral output part icon 151B generates vibration lower than the predetermined intensity.

As an example, a certain ventral output part icon 151C will be described (see FIGS. 10 to 13).

When the presentation target position pointer 153 is moved so that the ventral output part icon 151C located on the outer peripheral side of the attenuation region 155 changes to the state where it is located in the attenuation region 155, the presentation unit 8 or 45 corresponding to the ventral output part icon 151C starts to generate vibration lower than the predetermined intensity (FIG. 10).

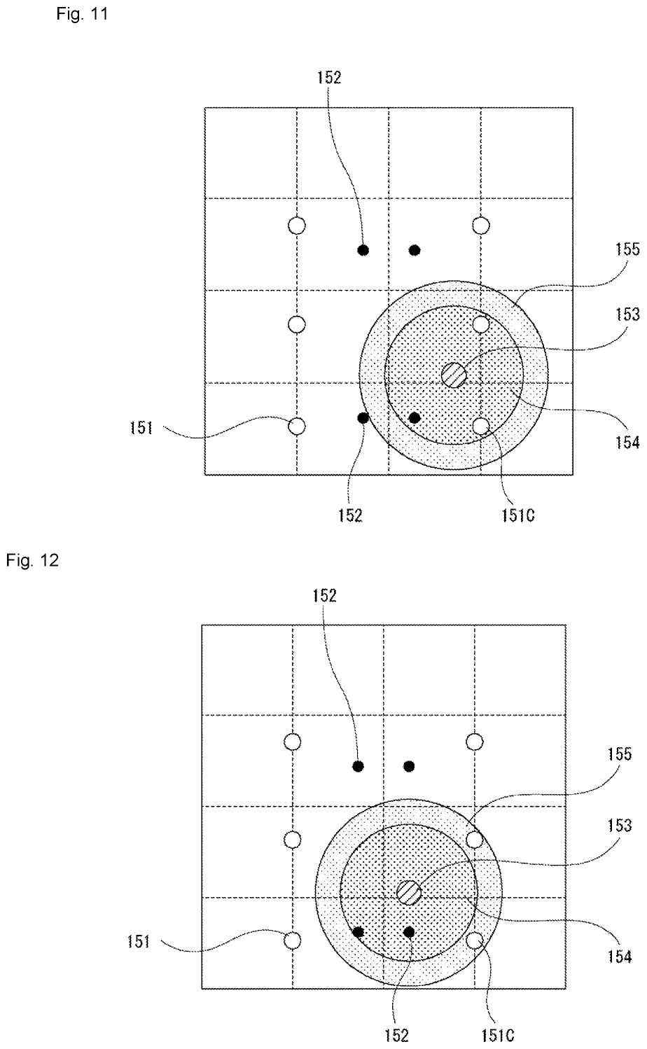

Further, when the presentation target position pointer 153 is moved so that the ventral output part icon 151C changes from the state where it is located in the attenuation region 155 to the state where it is located in the non-attenuation region 154, the vibration intensity is enhanced to a predetermined intensity (FIG. 11).

Further, when the presentation target position pointer 153 is moved so that the ventral output part icon 151C changes from the state where it is located in the non-attenuation region 154 to the state where it is located in the attenuation region 155 again, the vibration with the predetermined intensity is reduced (FIG. 12).

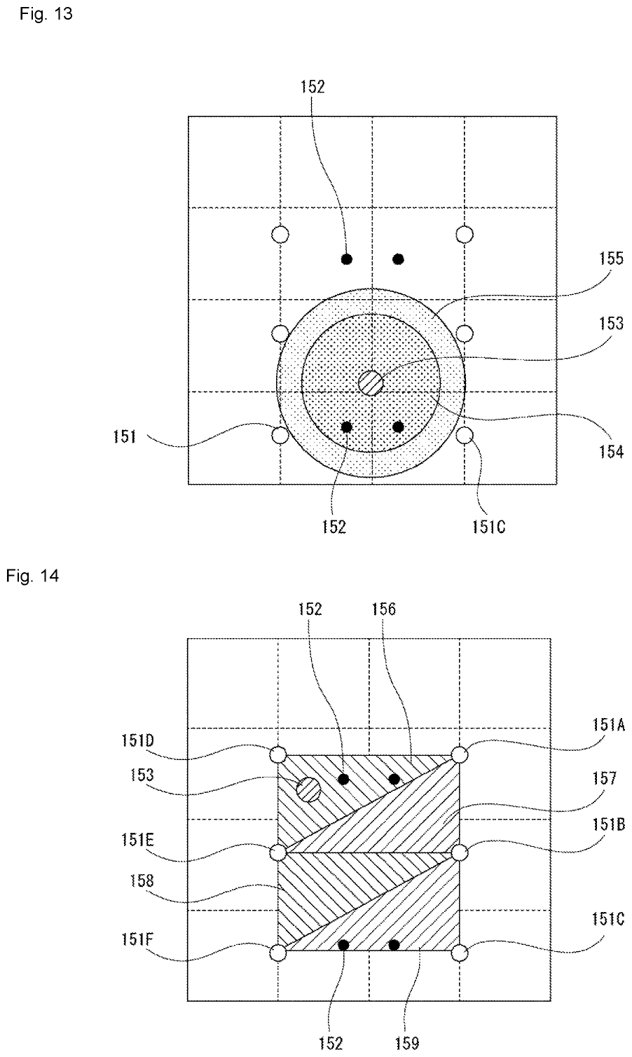

Further, when the presentation target position pointer 153 is moved so that the ventral output part icon 151C changes from the state where it is located in the attenuation region 155 to the state where it is located on the outer peripheral side of the attenuation region 155, the vibration is stopped (FIG. 13).

As described above, in the “circle mode”, the positional relationship between each ventral output part icon 151, the non-attenuation region 154, and the attenuation region 155 changes according to the locus of the presentation target position pointer 153, so that the output of the corresponding presentation unit 8 or 45 changes.

For tactile data to be created for giving a tactile stimulus on the back side of the wearer, the target icon is any of the back output part icons 152.

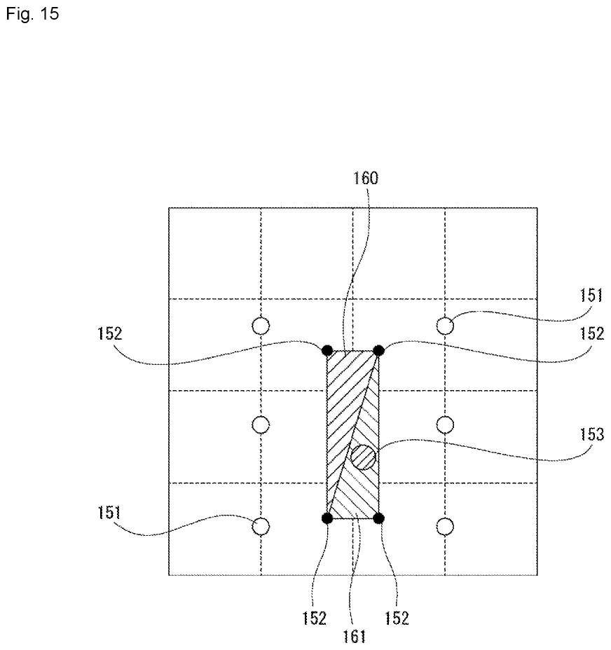

Next, the “triangle mode” will be described with reference to FIG. 15.

In the “triangle mode”, the non-attenuation region 154 and the attenuation region 155 are not displayed.

In the “triangle mode”, an algorithm is adopted for determining the presentation units 8 or 45 to be operated depending on which one of a plurality of triangular regions the presentation target position pointer 153 is located where each triangular region is defined as being formed by three back output part icons 152. In the following, tactile data for giving a tactile stimulus to the wearer on the front side will be taken as an example.

In the example illustrated in FIG. 14, the presentation target position pointer 153 is located in a first region 156 formed by the ventral output part icons 151A, 151D, and 151E.

In addition, a second region 157 formed by the ventral output part icons 151A, 151B, and 151E, a third region 158 formed by the ventral output part icons 151B, 151E, and 151F, and a fourth region 159 formed by the ventral output part icons 151B, 151C, and 151F are arranged.

When the presentation target position pointer 153 is located in the first region 156, the ventral output part icons 151A, 151D, and 151E are vibrated. The vibration intensities of the ventral output part icons 151A, 151D, and 151E each depend on, for example, the distance from the presentation target position pointer 153 or the distance from the other ventral output part icons 151.

As described above, in the “triangle mode”, the positional relationship between the presentation target position pointer 153 and each triangular region (the first region 156, the second region 157, the third region 158, or the fourth region 159) changes depending on the locus of the presentation target position pointer 153, and accordingly, the output of the corresponding presentation unit 8 or 45 changes.

For tactile data to be created for giving a tactile stimulus on the back side of the wearer in the “triangle mode”, the triangular regions formed by three back output part icons 152 are defined as a fifth region 160 and a sixth region 161 as illustrated in FIG. 15.

In the “auto mode” being selected, for example, the “circle mode” is basically selected, and when the target output part icon (the ventral output part icon 151 or the back output part icon 152) is not located in the non-attenuation region 154 or the attenuation region 155, the mode is switched to the “triangle mode”. When the target output part icon is not located in any triangular region set in the “triangle mode”, the mode may be switched to the “circle mode”.

FIG. 8 is referred back to for description.

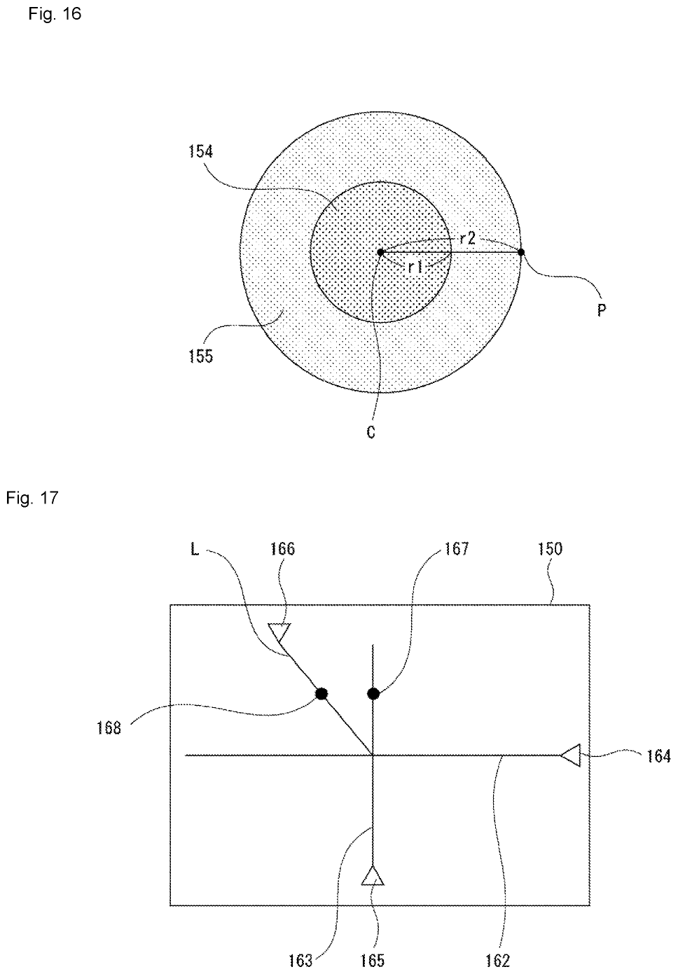

The circle shape specification part 150 is an operation region for setting the sizes of the non-attenuation region 154 and the attenuation region 155 in the “circle mode”. This will be specifically described with reference to FIGS. 16 and 17.

FIG. 16 illustrates the center C of the presentation target position pointer 153, the non-attenuation region 154, and the attenuation region 155. The radius of the non-attenuation region 154 is a radius r1, and the distance between the outermost edge of the attenuation region 155 and the center C is a radius r2.

The presentation unit 8 or 45 corresponding to the ventral output part icon 151 located in the non-attenuation region 154 vibrates with a predetermined vibration intensity STR set by the corresponding presentation unit 8 or 45.

The presentation unit 8 or 45 corresponding to the ventral output part icon 151 located at the outermost edge of the attenuation region 155 (for example, a point P in the figure) vibrates with a vibration intensity MIN lower than the predetermined vibration intensity STR. For example, the vibration intensity MIN is calculated by multiplying the vibration intensity STR by a coefficient B (B is a value of 0 or more and 1 or less).

The presentation unit 8 or 45 corresponding to the ventral output part icon 151 located at a place other than the outermost edge in the attenuation region 155 vibrates with a vibration intensity lower than the vibration intensity STR and higher than the vibration intensity MIN. That vibration intensity is calculated so as to decrease linearly as the distance from the center C increases.

A horizontal axis 162 and a vertical axis 163 are displayed in the circle shape specification part 150. Further, a horizontal axis control 164 for moving the horizontal axis 162 up and down is disposed. The position of the horizontal axis 162 in the up-and-down direction represents the coefficient B. Specifically, moving the horizontal axis control 164 upward increases the vibration intensity MIN at the outermost edge in the attenuation region 155. In addition, moving the horizontal axis control 164 upward reduces the vibration intensity MIN.

In the circle shape specification part 150, a vertical axis control 165 for moving the vertical axis 163 left and right is disposed. The position of the vertical axis 163 in the left-and-right direction represents the size of the radius r2. The minimum value of the vertical axis 163 is a radius r1 of the non-attenuation region 154.

Changing the radius r2 also changes a radius R of the circular region disposed around the presentation target position pointer 153.

In the circle shape specification part 150, a ratio control 166 for changing the radius r1 of the non-attenuation region 154 is disposed. The ratio control 166 can be moved in the left-and-right direction so that moving the ratio control 166 to the left reduces the radius r1, and moving the ratio control 166 to the right increases the radius r1. Even when the radius r1 is changed by using the ratio control 166, the size of the radius r2 does not change. Specifically, changing the radius r1 makes it possible to change only the area ratio between the non-attenuation region 154 and the attenuation region 155 without changing the area of the combined region of the non-attenuation region 154 and the attenuation region 155. In other words, the ratio control 166 is a control for changing a ratio A (=r1/r2).

A first control 167 is disposed on the vertical axis 163, and a second control 168 is disposed on a line connecting the intersection (origin) of the horizontal axis 162 and the vertical axis 163 and the ratio control 166.

Both the first control 167 and the second control 168 are controls for changing the respective parameters while keeping the attenuation factor of vibration with respect to the distance from the center C in the attenuation region 155 constant. That attenuation factor is represented by the inclination of a line segment L connecting the origin and the ratio control 166 in FIG. 17. The larger the slope of the line segment L, the higher the attenuation factor. Different attenuation factors give the wearer different perceptions of how a tactile stimulus spreads. For example, a higher attenuation factor makes it possible to give a perception of a state in which a given stimulus does not spread over a wide area. On the other hand, a lower attenuation factor makes it possible to give a perception of a stimulus that gradually spreads as a whole.

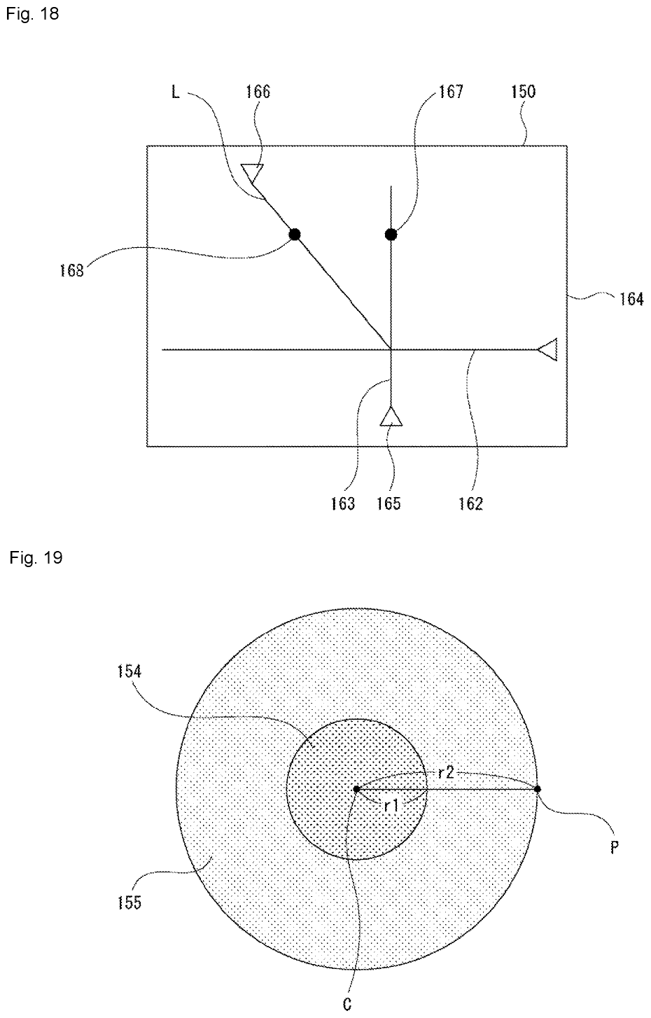

The operation of moving the first control 167 to the right is to move the horizontal axis 162 downward and the vertical axis 163 to the right without changing the position of the ratio control 166 and the inclination of the line segment L (See FIG. 18). As a result, the range in which a tactile stimulus is given can be increased without changing how the wearer feels about the spread of the tactile stimulus (see FIG. 19). The operation of moving the first control 167 to the left is to move the horizontal axis 162 upward and the vertical axis 163 to the left without changing the position of the ratio control 166 and the inclination of the line segment L.

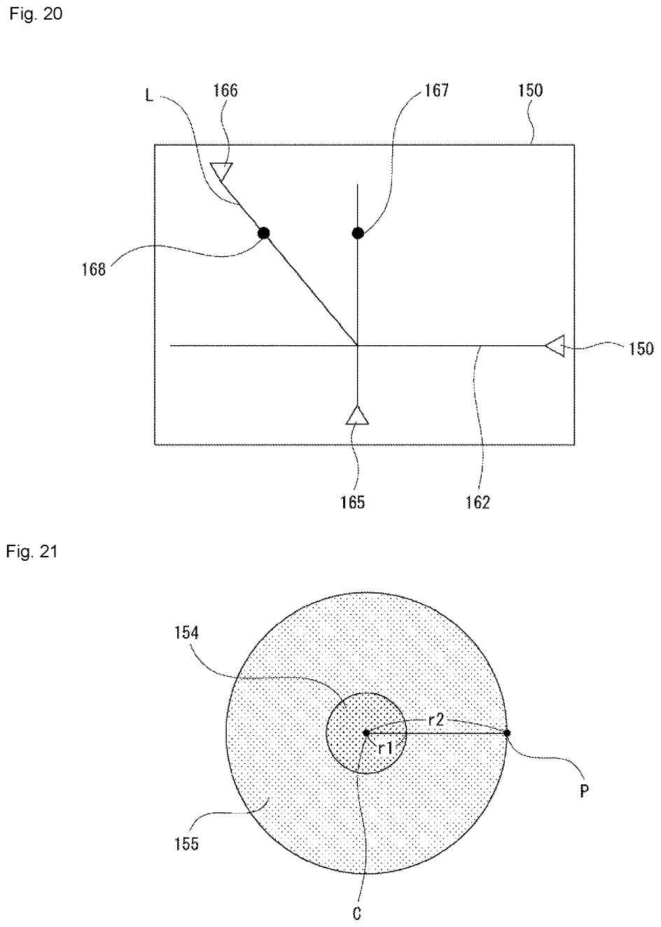

The operation of moving the second control 168 to the left is to move the horizontal axis 162 downward and the ratio control 166 to the left without changing the vertical axis control 165 and the inclination of the line segment L (see FIG. 20). As a result, the non-attenuation region 154 can be reduced without changing how the wearer feels about the spread of the tactile stimulus. In other words, it is possible to perceive as if a tactile stimulus was given more locally (see FIG. 21). The operation of moving the second control 168 to the right is to move the horizontal axis 162 upward and the ratio control 166 to the right without changing the vertical axis control 165 and the inclination of the line segment L.

### (Operation Setting Region 142)

FIG. 8 is referred back to for description.

In the operation setting region 142, a mode setting part 169, a face direction setting part 170, and an automatic note setting part 171 are arranged.

The mode setting part 169 is a control for switching modes. The mode setting part 169 allows for switching between the “view mode” and the “edit mode”.

The face direction setting part 170 is a control for specifying a direction of the face of the operator who wears the tactile presentation device 7 to select the creation of tactile data on the front side of the operator's body or the creation of tactile data on the back side of the body.

The automatic note setting part 171 is a control for switching the note-on operation when a mouse operation is performed on the coordinate area 146. For example, when the automatic note is set to “On”, note-on is automatically enabled while the left mouse click is pressed in the state where the mouse cursor is located in the coordinate area 146. When the left mouse click being pressed is released, note-off is automatically enabled.

When the automatic note is set to “Off”, it is determined whether the note-on state or the note-off state according to the setting of a note setting part 174, which will be described later.

“Note-on” indicates a state in which tactile data is created according to a locus of the mouse cursor. In other words, it is a state in which the presentation unit(s) 8 or 45 to be operated according to the locus of the mouse cursor and the vibration intensity are determined and stored as tactile data.

“Note-off” is a state where tactile data is not created even when the mouse cursor is moved. Alternatively, it may be in a state where tactile data indicating that tactile presentation is not to be performed is created.

### (Note Region 143)

In the note region 143, a library selection part 172, a velocity setting part 173, and the note setting part 174 are arranged.

The library selection part 172 is a control to be operated to select a tactile library. This allows for selecting a tactile library used for tactile data to be created.

The velocity setting part 173 is a control for changing the intensity of the tactile stimulus. As a control for changing the intensity of the tactile stimulus, a volume setting part 175, which will be described later, is disposed other than the velocity setting part 173.

By setting either the velocity setting part 173 or the volume setting part 175 to the minimum value, the intensity of the tactile stimulus becomes 0.

The note setting part 174 is a control for manually switching between the note-on and the note-off. When the automatic note is set to “on” in the automatic note setting part 171, any operation on the note setting part 174 becomes disabled.

### (Channel Region 144)

In the channel region 144, the volume setting part 175, a pitch setting part 176, and a time stretch setting part 177 are arranged.

The volume setting part 175 is a control for changing the intensity of the tactile stimulus, in which the intensity of the tactile stimulus is determined in combination with a value set by the velocity setting part 173. The numerical value disposed at the lower right of the control represents a volume value. A specific operation performed on the notation of the volume value makes it possible to change the volume value to a default value.

The pitch setting part 176 is a control for changing the pitch of the vibration waveform. Changing the pitch changes the frequency of the vibration waveform.

The time stretch setting part 177 is a control for expanding and contracting the vibration waveform in the time direction.

### (Timeline Region 145)

In the timeline region 145, a time-series data display area 178, a display/non-display switching control group 179, a note link control 180, a scroll control 181, an in/out control 182, a toggle control 183, a zoom-in control 184, a zoom-out control 185, a preset selection part 186, a preset save button 187, a preset delete button 188, a mode selection part 189, a reproduction button 190, a stop button 191 and a sync setting control 192 are arranged.

The time-series data display area 178 is a region in which time-series data created in response to an operation on the presentation target position pointer 153, performed in the coordinate area 146, is displayed. The time-series data display area 178 allows for displaying not only the time-series data of the X-coordinate and the time-series data of the Y-coordinate, which are represent the position of the presentation target position pointer 153, but also the time-series data of other information. A library information display area 178a for displaying tactile library information is disposed at the lower end of the time-series data display area 178. The information to be displayed in the library information display area 178a will be described later.

The display/non-display switching control group 179 is a group of controls for selecting information to be displayed in the time-series data display area 178. The display/non-display switching control group 179 is composed of a plurality of buttons for switching between display and non-display for each piece of information.

Specifically, the display/non-display switching control group 179 includes: an X button 179X for switching between the display and non-display of the time-series data of the X coordinate, a Y button 179Y for switching between the display and non-display of the time-series data of the Y coordinate, a Z button 179Z for switching between the display and non-display of the time-series data of the Z coordinate, a pitch button 179P for switching between the display and non-display of the time-series data of pitch information, a stretch button 179S for switching between the display and non-display of the time-series data of time stretch information, a volume button 179V for switching between the display and non-display of the time-series data of volume information, a note button 179N for switching between the display and non-display for note-on time zone, a type button 179T for switching between the display and non-display of time-series data for different types (circle mode or triangle mode), an A button 179A for switching between the display and non-display of the time-series data of the ratio A in the circle mode, a B button 179B for switching between the display and non-display of the time-series data of the coefficient B in the circle mode, and an R button 179R for switching between the display and non-display of the time-series data of the radius R in the circle mode.

The time-series data display area 178 allows for editing the time-series data for the displayed information. Specifically, it allows for editing each piece of information displayed in a line graph in the coordinate area 146 by a drag operation.

Details thereof will be described below.

The note link control 180 is a control for selecting whether or not to link a “note”, which is a vibration period, with the time-series data of each piece of information (for example, X coordinate, Y coordinate). In the case of linking, when the note is moved in the time direction, the time-series data of the X coordinate and the Y coordinate are also moved.

The scroll control 181 is a control for automatically adjusting the display position of the time-series data in the timeline region 145 in accordance with the position of a timeline cursor TC.

The timeline cursor TC is a linear icon extending up and down to indicate a record position and a reproduction position on the time axis.

When the automatic adjustment is set to be on by operating the scroll control 181, the time-series data is displayed so that it moves from right to left over time while the left and right positions of the timeline cursor TC are fixed in the time-series data display area 178, for example.

The in/out control 182 is a control for enabling/disabling the setting of an in-point and an out-point. For example, when the in/out setting is set to “on” with the in-point and out-point having been set, the timeline cursor TC is moved to the time specified for the in-point at the same time as a reproduction operation, and then reproduction is started at the in-point. When the time specified by the out-point is reached, the reproduction ends.

The toggle control 183 is a control for switching between the display state and the non-display state of the respective buttons (the X button 179X, the Y button 179Y, the Z button 179Z, the pitch button 179P, the stretch button 179S, the volume button 179V, the note button 179N, the type button 179T, the A button 179A, the B button 179B, and the R button 179R) which belong to the display/non-display switching control group 179.

The zoom-in control 184 is a control for performing zoom-in display in the time-series data display area 178.

The zoom-out control 185 is a control for performing zoom-out display in the time-series data display area 178.

The preset selection part 186 is a control for selecting preset data to be called. The preset data is data in which the setting states of the controls such as options and buttons arranged in the parts of the creation screen 102 of FIG. 8 are stored. The preset data may include time-series data. Specifically, by calling the preset data, the previously created tactile data may be read.

The preset save button 187 is a control for storing the state of each control on the current creation screen 102 as preset data. Meanwhile, the time-series data may be stored together.

The preset delete button 188 is a control for deleting the selected preset data from the list of the preset selection part 186.

The mode selection part 189 is a control for changing the mode for the reproduction of the time-series data of each piece of information displayed in the time-series data display area 178.

The mode selection part 189 allows for setting one of the modes “READ”, “WRITE”, “TOUCH”, and “LATCH”.

The “READ” mode is a mode in which reproduction is performed reflecting the time-series data of each piece of information displayed in the time-series data display area 178. This is also a mode in which any operation of changing the time-series data is not allowed.

The “WRITE” mode is a mode in which all time-series data is allowed to be overwritten during reproduction.

The “TOUCH” mode is a mode in which only the changed part of the time-series data changed during reproduction is allowed to be overwritten.

As with the “TOUCH” mode, the “LATCH” mode is a mode in which only the changed part of the time-series data changed during reproduction is allowed to be overwritten. This differs from the “TOUCH” mode in that the last changed value is maintained until reproduction is stopped.

The reproduction button 190 is a control for performing reproduction of the time-series data in the mode selected in the mode selection part 189.

The stop button 191 is a control for stopping the reproduction of the time-series data.

The sync setting control 192 is a control for switching on/off of the synchronization setting for other MIDI devices.

### 4. Operation Example

<4-1. Creation Operation on Tactile Data>

A flow of operation for creating tactile data will be described with reference to the accompanying drawings.

First, various controls arranged in the snap setting part 147, the coordinate slider 148, the type setting part 149, and the circle shape specification part 150, which are of the position region 141, and in the operation setting region 142, the note region 143, and the channel region 144 are operated to set the creation environment.

For example, the mode setting part 169 of the operation setting region 142 is operated to set the “edit mode”. Further, the library selection part 172 of the note region 143 is used to select a desired tactile library (for example, “lib_002”). Further, the automatic note setting part 171 is operated to change the automatic note to the “on” setting. In addition, an operation is performed on the type setting part 149 of the operation setting region 142 to set the presentation target position pointer 153, the non-attenuation region 154, and the attenuation region 155.

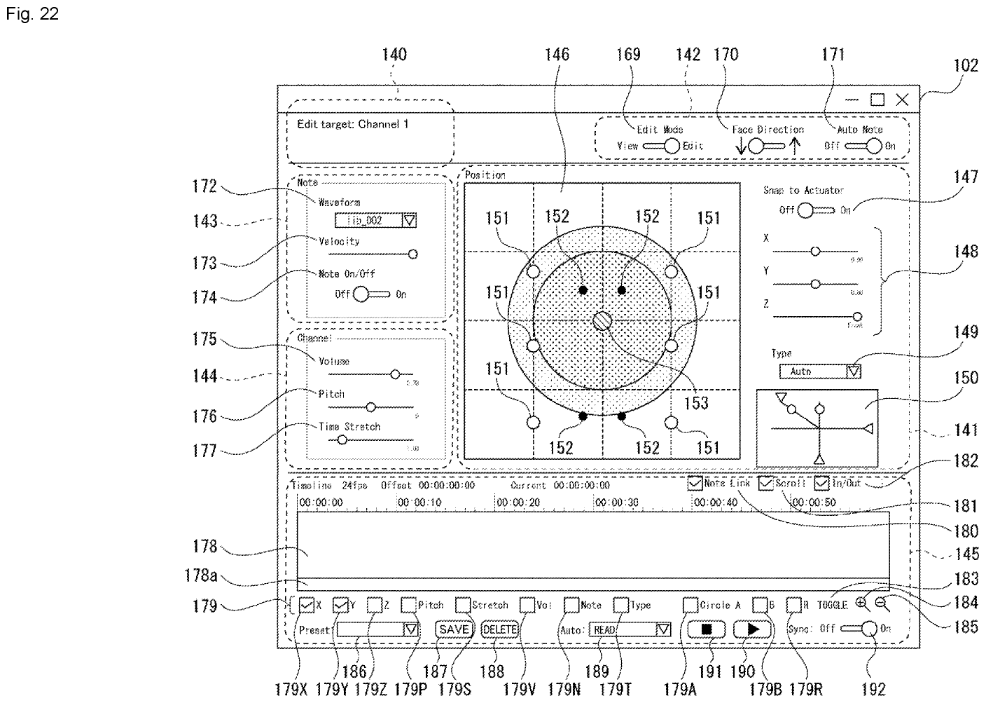

FIG. 22 illustrates the state in which such settings have been made.

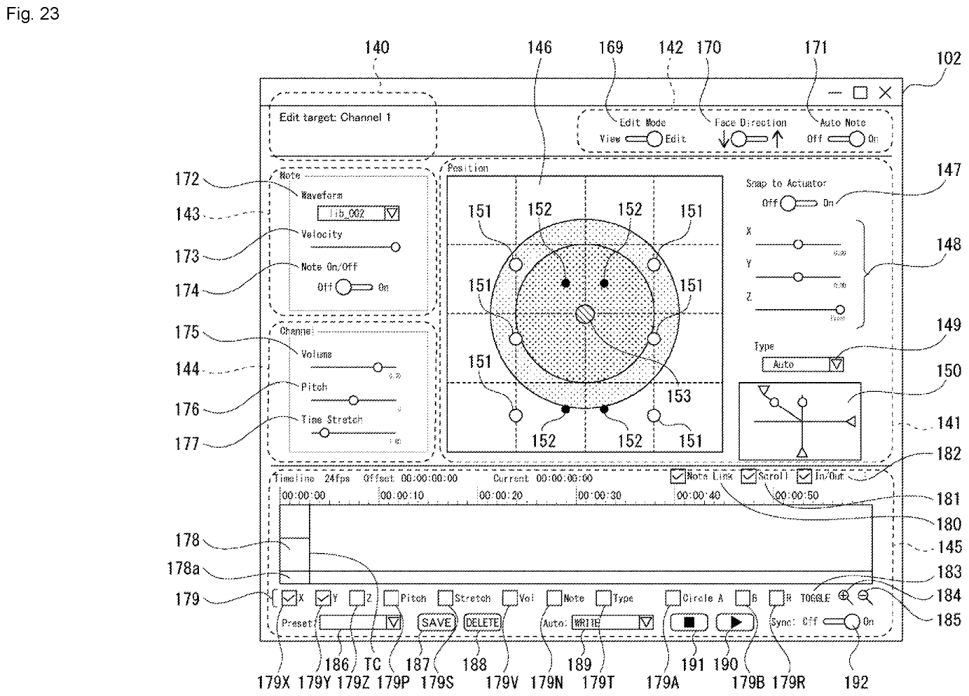

Next, operations are performed in which the “WRITE” mode is selected in the mode selection part 189 and the reproduction button 190 is pressed. As a result, the timeline cursor TC indicating the current reproduction position starts to move to the right from the left end in the time-series data display area 178. FIG. 23 is a diagram illustrating the state of the creation screen 102 after a predetermined time has elapsed since the reproduction button 190 was pressed.

In the following, a case will be described in which, of pieces of data on tactile data, only the time-series data of the X coordinate and the time-series data of the Y coordinate are to be changed. In addition, of the controls included in the display/non-display switching control group 179, only the X button 179X and the Y button 179Y are set to be displayed, and the other time-series data are set to be hidden.

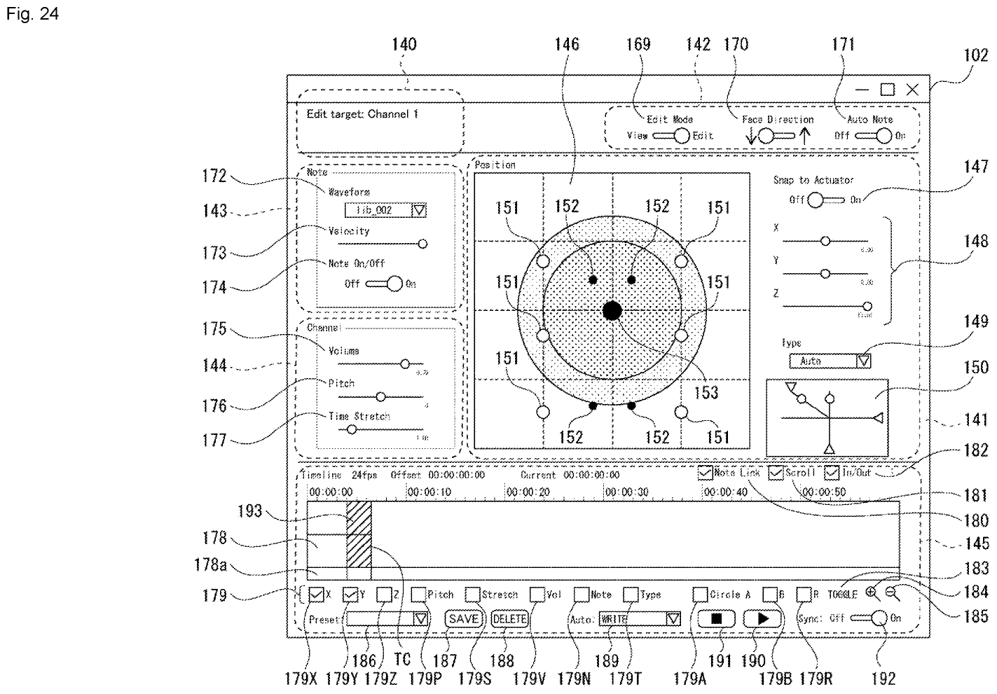

Next, a left-click operation is performed with the mouse cursor being located in the coordinate area 146 to specify the start of the vibration period. As a result, as illustrated in FIG. 24, the display mode of the presentation target position pointer 153 is changed to a mode indicating that the vibration period is in progress (diagonal hatching is changed to black solid). In addition, the note setting part 174 is also displayed to show that it is in the note-on state.

Further, the left end of the hatched region in the time-series data display area 178 is set as the start time of the vibration period. In the following description, this hatched region will be referred to as “note-on region 193”.

The height of the note-on region 193 represents the intensity of the tactile stimulus. Specifically, for example, it represents a velocity value.

The display of the coordinate slider 148 corresponds to the position of the presentation target position pointer 153.

The state illustrated in FIG. 24 indicates a state in which a predetermined time has elapsed since the vibration period was started by performing a left-click operation with the mouse cursor being located in the coordinate area 146.

Next, in order to express the tactile data in which the tactile stimulus moves from the center on the front surface of the wearer to the left flank as viewed from the wearer, the mouse cursor is moved to the lower right while the left-click operation is held.

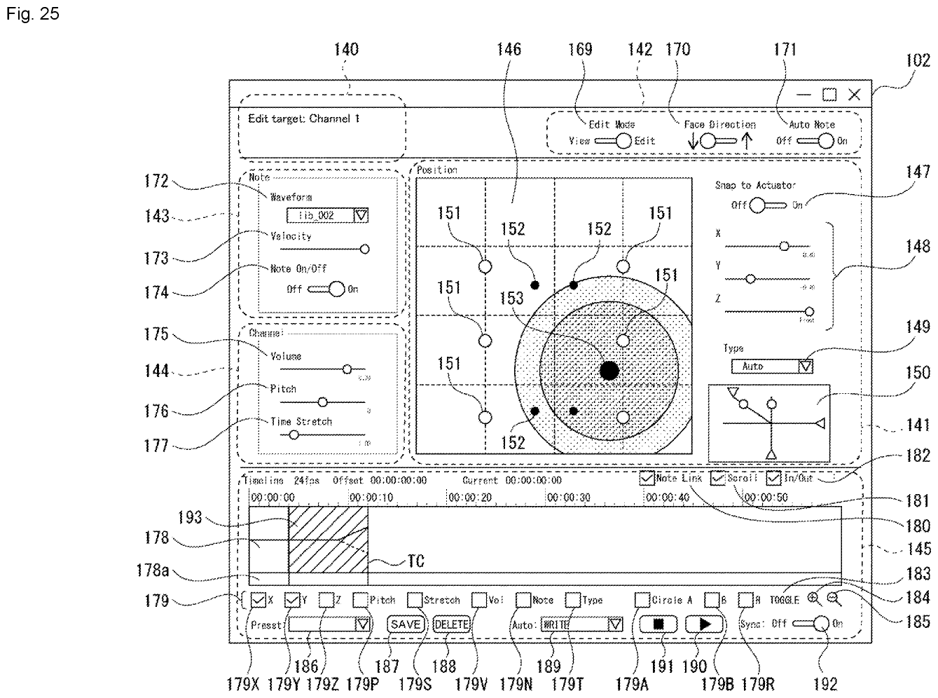

As a result, as illustrated in FIG. 25, the movement locus of the presentation target position pointer 153 is displayed in the time-series data display area 178. In each figure, the X coordinate locus is represented by a solid line, and the Y coordinate locus is represented by a broken line.

Further, the smaller the X coordinate (the closer to the left of the coordinate area 146), the lower the X coordinate locus in the time-series data display area 178 moves, and the larger the X coordinate (the closer to the right of the coordinate area 146), the upper the X coordinate locus in the time-series data display area 178 moves.

Further, the smaller the Y coordinate (the closer to the bottom of the coordinate area 146), the lower the Y coordinate locus in the time-series data display area 178 moves, and the larger the Y coordinate (the closer to the top of the coordinate area 146), the upper the Y coordinate locus in the time-series data display area 178 moves.

The display of the coordinate slider 148 is appropriately changed depending on the position of the presentation target position pointer 153 as appropriate.

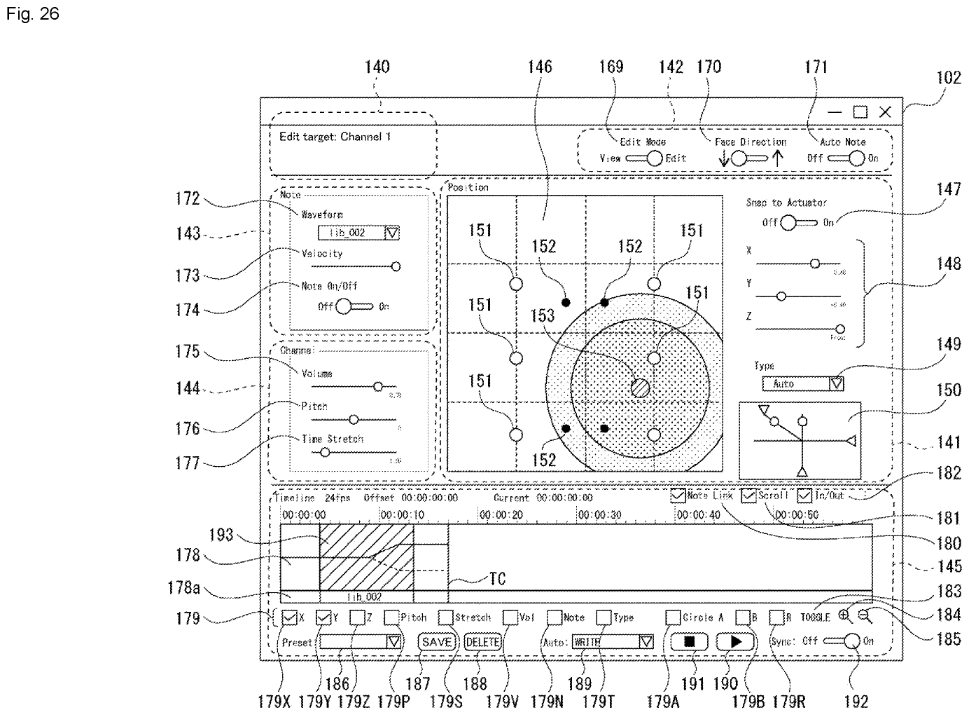

When the stop of the vibration period is instructed by releasing the left-click operation on the mouse in the state illustrated in FIG. 25, the display mode of the presentation target position pointer 153 is changed to a mode indicating that it is in the non-vibration period, as illustrated in FIG. 26. In addition, the note setting part 174 is also displayed to show that it is in the note-off state.

By determining the end time of the vibration period, one note-on region 193 is determined. In other words, the right end of the hatched region represents the end time of the vibration period.

Further, as information for identifying the tactile library selected (or being selected) in the library selection part 172 in FIG. 22, for example, a part of the file name (lib_002) is displayed. The tactile library information to be displayed in the library selection part 172 can be changed later.

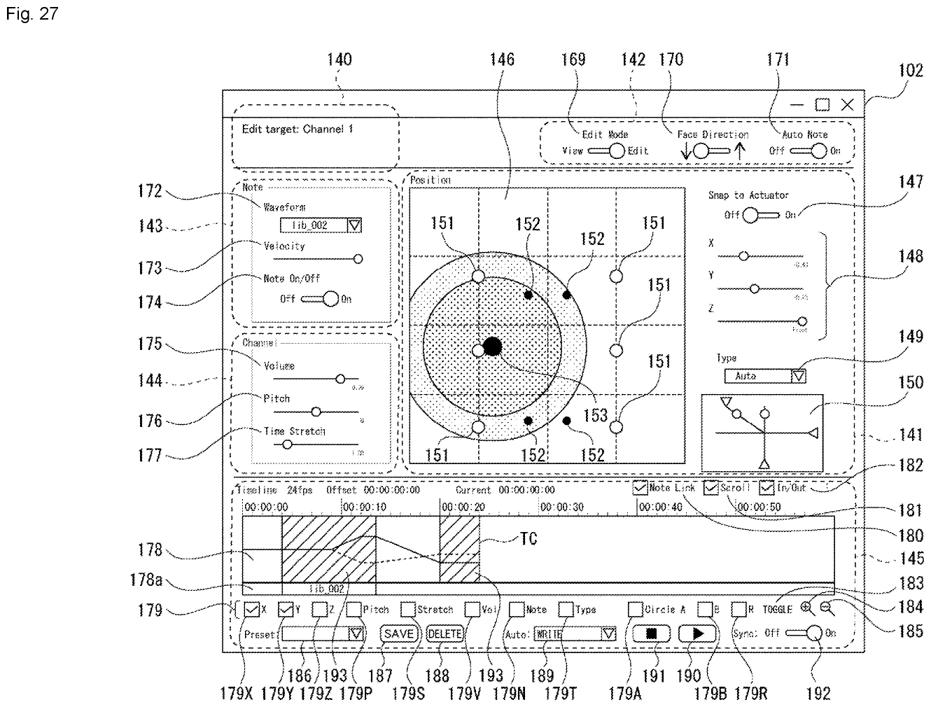

Subsequently, when the left-click operation of the mouse is performed with the mouse cursor being located at a place other than the presentation target position pointer 153 in the coordinate area 146 (see FIG. 27), the next vibration period is started.

In addition, the presentation target position pointer 153 is moved to the position of the mouse cursor when the left-click operation is performed.

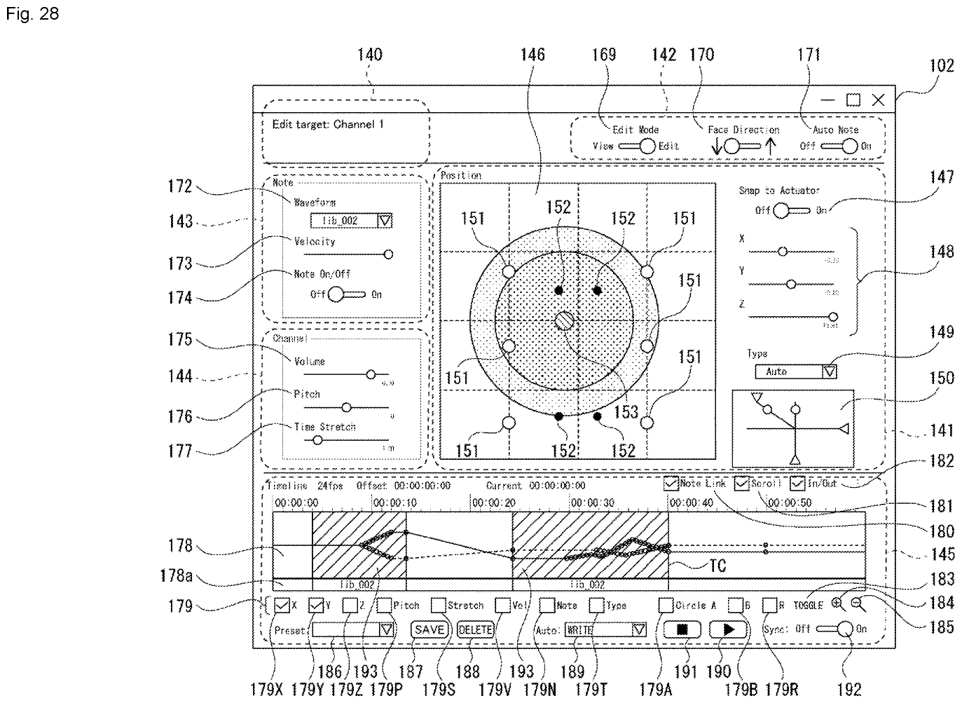

By performing the left-click operation of the mouse, the movement operation of the mouse cursor, and the release of the left-click operation in this way, for example, time-series data as illustrated in FIG. 28 is created.

As illustrated in FIG. 28, circular points may be displayed at the change points of the X coordinate and the Y coordinate.

### <4-2. Reproduction Operation on Tactile Data>

On the creation screen 102 illustrated in FIG. 28, when the “READ” mode is selected in the mode selection part 189 and the reproduction button 190 is pressed, reproduction processing is performed on the tactile data based on the time-series data displayed in the time-series data display area 178. The term “reproduction” as used herein refers to display such that changes in the time-series data with time can be seen to visually confirm the created tactile data.

In the reproduction processing, animation display of the presentation target position pointer 153 based on the time-series data is performed in the coordinate area 146. Accordingly, animation display of the X coordinate, the Y coordinate, and the Z coordinate of the presentation target position pointer 153 is performed in the coordinate slider 148 in synchronization with the animation display of the presentation target position pointer 153.

Similarly, also for the velocity setting part 173 in the note region 143, and the volume setting part 175, the pitch setting part 176, and the time stretch setting part 177 in the channel region 144, their animation display is performed based on the time-series data.

Even for data hidden in the time-series data display area 178, the above-mentioned animation display is performed based on the time-series data.

### <4-3. Modification Operation on Tactile Data>

There are prepared a plurality of modification operations on tactile data. For example, the tactile data may be recreated from scratch by selecting the “WRITE” mode in the mode selection part 189, or may be partially modified by selecting the “TOUCH” mode or the “LATCH” mode.

In the following description, a method of selecting the “TOUCH” mode to partially modify various types of time-series data will be described.

On the creation screen 102 illustrated in FIG. 28, when the “TOUCH” mode is selected in the mode selection part 189 and the reproduction button 190 is pressed, reproduction processing is performed on the tactile data based on the time-series data displayed in the time-series data display area 178.

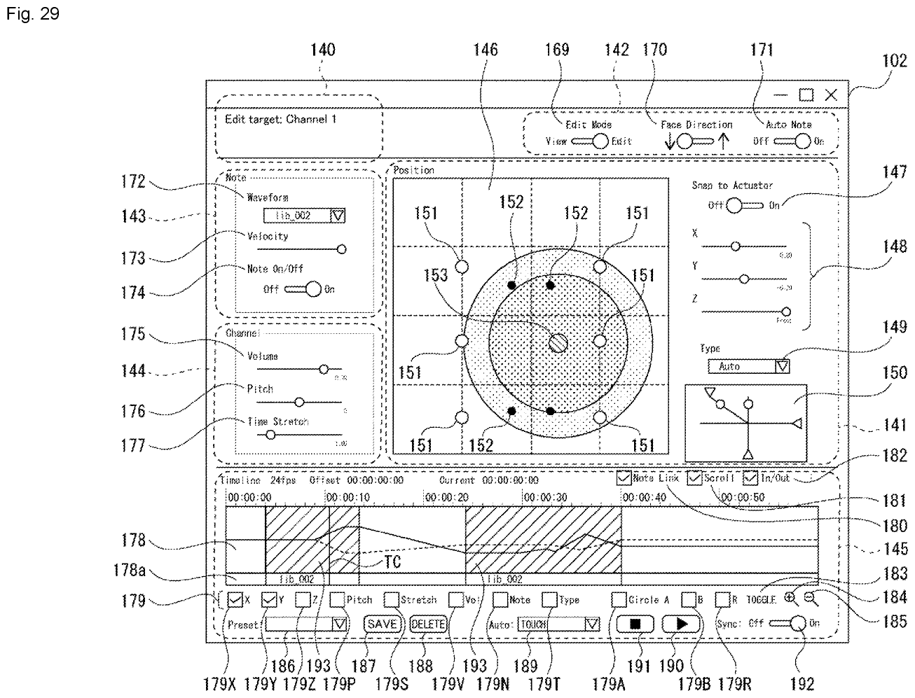

FIG. 29 illustrates a state in which the timeline cursor TC starts to move to the right from the left end in the time-series data display area 178 and a predetermined time has elapsed.

As illustrated in the figure, each part in the coordinate area 146, the coordinate slider 148, and the note region 143, and each part in the channel region 144 indicate the time-series data corresponding to the reproduction position indicated by the timeline cursor TC.

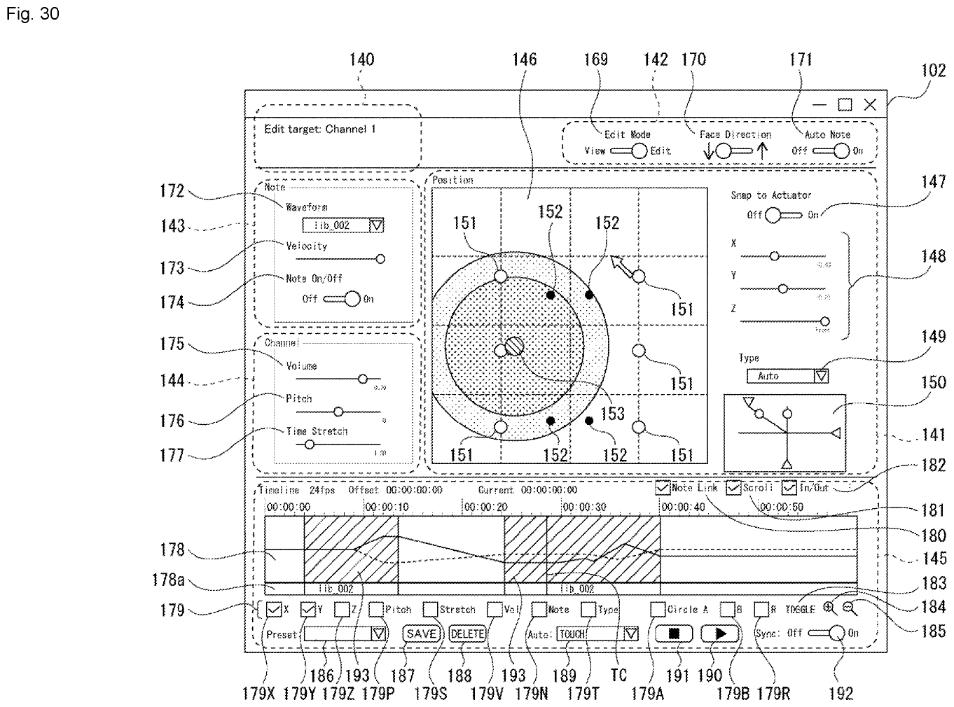

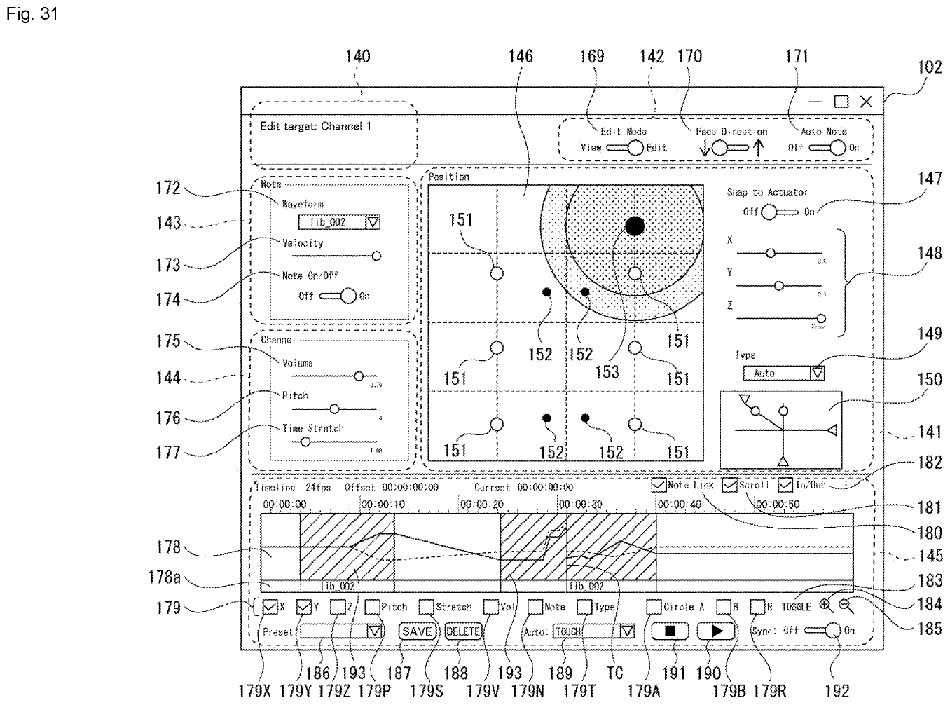

FIG. 30 illustrates a state in which a further time has elapsed from the state illustrated in FIG. 29. The state indicates that the timeline cursor TC is located in the note-on region 193 that is the later in time. FIG. 31 illustrates a state in which after the operator performed a mouse left-click operation with a mouse cursor MC moved to the position where the X coordinate is 0.3 and the Y coordinate is 0.5 in the state illustrated in FIG. 30, an operation of moving the mouse cursor to the position where the X coordinate is 0.5 and the Y coordinate is 0.7 (drag operation) has been performed.

As illustrated in the figure, it can be seen that the time-series data of the X coordinate and the Y coordinate of the corresponding part in the time-series data display area 178 has been overwritten according to the operation of moving the mouse cursor MC while the mouse left-click operation is held.

In this way, by using the “TOUCH” mode or the “LATCH” mode, the time-series data can be modified while the recorded time-series data is reproduced.

Subsequently, another example of the modification operation on the tactile data will be described. In this modification operation, the time-series data is modified by performing an operation on the time-series data display area 178. In the drawings referred to for explanation, only the time-series data display area 178 is illustrated, and the other areas are not illustrated.

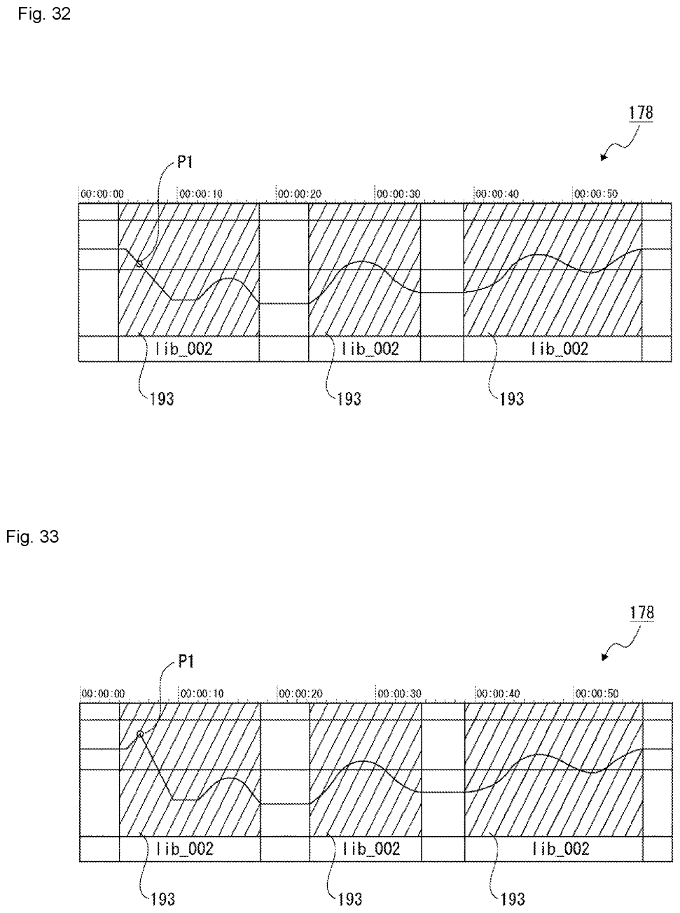

FIG. 32 illustrates the time-series data display area 178 in which only one piece of time-series data is displayed. The displayed piece of time-series data may be of the X-coordinate, the Y-coordinate, the volume value, or other time-series data.

For example, a drag operation of moving a predetermined point P1 on the time-series data upward makes it possible to change the time-series data as illustrated in FIG. 33.

For the time-series data for the radius R to be subjected to a change operation, a modification operation can be performed to change the area of the attenuation region 155 over time.

This modification method does not perform the modification operation while reproducing the time-series data, and thus it is easy to create the intended time-series data and tactile data.

In this modification method, a tactile library can be easily changed and a velocity value can be easily changed.

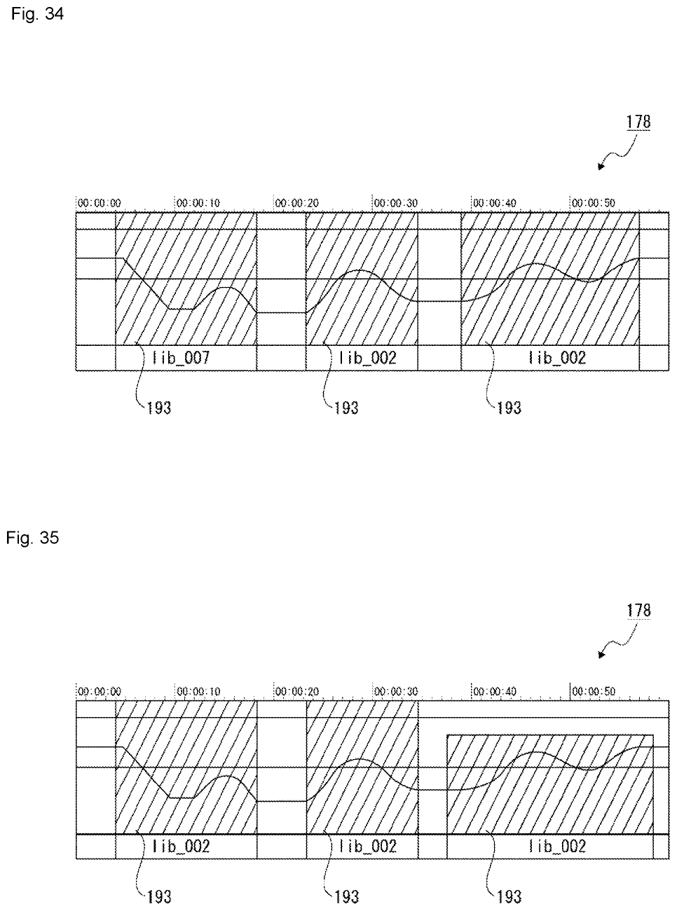

For example, in the library information display area 178a, a part of the file name of a tactile library is displayed so that the corresponding tactile library can be known for each vibration period. An operation being performed on the library information display area 178a makes it possible to change the tactile library associated with each note-on region 193 as illustrated in FIG. 34.

Changing the height and width of the note-on region 193 makes it possible to change the time length for the note-on and change the velocity value as illustrated in FIG. 35.

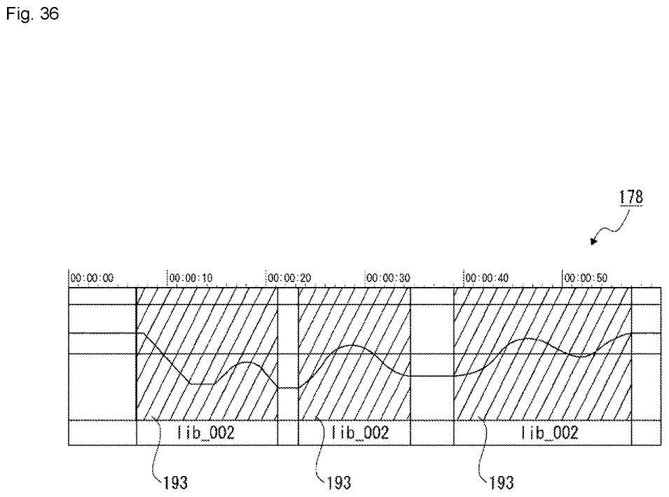

In addition, an operation of moving the note-on region 193 in the time direction is allowed. This makes it possible to make fine adjustments on the start time of the vibration period that deviates from the video content of the movie. When the note-on region 193 is moved in the time direction, the time-series data can also be moved at the same time. This is achieved by changing the note link control 180 illustrated in FIG. 8 to the on setting (see FIG. 36).

### 5. UI Screen in Tactile Presentation Control Device

The tactile data created using the tactile data creation system 1 is transmitted to the tactile presentation control device 43 (or the provision control device 41) actually installed in a movie theater or the like and is reproduced, so that a tactile stimulus can be generated in the presentation unit 45 included in the vest-type tactile presentation device 44 worn by a user who visits the movie theater.

In the tactile presentation control device 43 and the like, software for making a final adjustment on the tactile data is installed. Such a final adjustment, which can be made on the tactile data in the tactile presentation control device 43 and the like, makes it possible to provide, for example, a tactile stimulus adjusted according to the customer segment.

Hereinafter, a UI screen on software for making the final adjustment will be described with reference to the accompanying drawing.

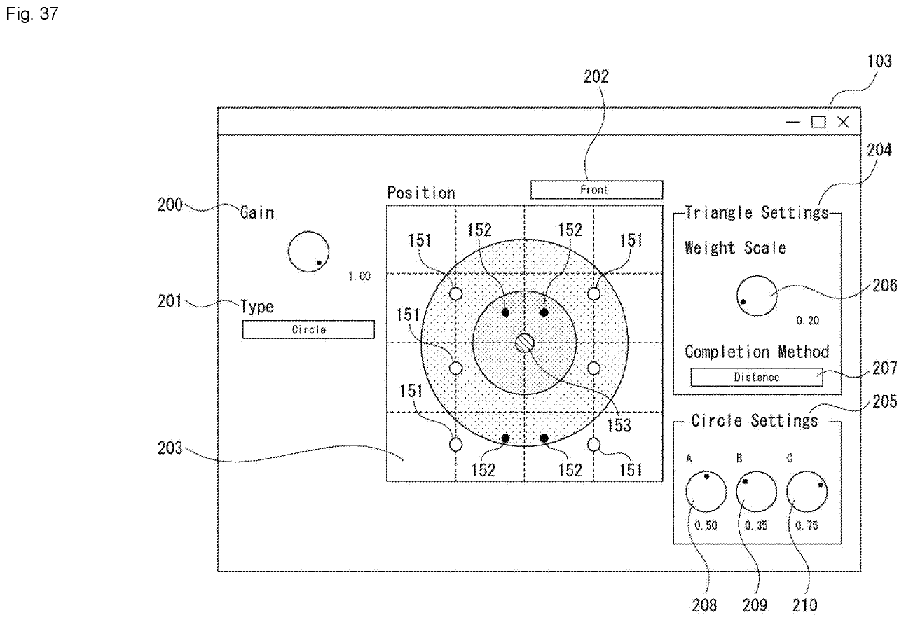

FIG. 37 illustrates an adjustment screen 103 displayed on the display unit when the software is started.

On the adjustment screen 103, a gain adjustment part 200, a type adjustment part 201, a position adjustment part 202, a coordinate area 203, a triangle setting area 204, and a circle setting area 205 are arranged.

The gain adjustment part 200 is a control for adjusting the magnitude of the tactile stimulus to be presented to the wearer.

The type adjustment part 201 is a control for determining which of the plurality of presentation units 45 included in the tactile presentation device 44 is to be driven to provide the tactile stimulus to the wearer. For example, one can be selected from among the above-mentioned “circle mode”, “triangle mode”, and “auto mode”.

The position adjustment part 202 is a control for switching the tactile data to be displayed between the tactile data for providing a tactile stimulus to the ventral side of the wearer and the tactile data for providing a tactile stimulus to the back side.

The coordinate area 203 is a region indicating the target position of tactile presentation using the tactile data, and is a region in which the same display as the coordinate area 146 described above is performed. Specifically, in the coordinate area 203, the ventral output part icons 151, the back output part icons 152, the presentation target position pointer 153, the non-attenuation region 154, and the attenuation region 155 are displayed. Further, when the tactile data is reproduced, animation display is performed based on the time-series data of the X coordinate and the Y coordinate of the presentation target position pointer 153.

In the triangle setting area 204, adjustment items for the “triangle mode” being set are arranged. Specifically, in the triangle setting area 204, a weight scale adjustment part 206 and a completion method selection part 207 are arranged.

The weight scale adjustment part 206 is a control for changing the calculation algorithm for the output intensities of three output part icons (the ventral output part icons 151, the back output part icons 152) that form a region in which the presentation target position pointer 153 is located of the first region 156 to the sixth region 161.

The completion method selection part 207 is a control for switching algorithms.

In the circle setting area 205, adjustment items for the “circle mode” being set are arranged. Specifically, in the circle setting area 205, a ratio A adjustment control 208, a coefficient B adjustment control 209, and a radius R adjustment control 210 are arranged.

The ratio A adjustment control 208 is a control for adjusting the ratio A, which is the ratio between the radius r1 of the non-attenuation region 154 and the radius r2 of the attenuation region 155 described with reference to FIG. 16.

The coefficient B adjustment control 209 is a control for adjusting the coefficient B for defining the vibration intensity MIN at the outermost edge of the attenuation region 155 described with reference to FIG. 16.

The radius R adjustment control 210 is a control for adjusting the radius R (=r2) of the region including the non-attenuation region 154 and the attenuation region 155 described with reference to FIG. 16.

As described above, the UI screen on which at least a part of the tactile data can be changed makes it possible to provide the wearer with a tactile stimulus customized for each movie theater, for example.

By narrowing down the items that can be customized, for example, setting only the volume to be changeable, it is possible to perform customization for each movie theater while reflecting the intention of the creator of the tactile data.

### 6. Conclusion

As described in each of the above examples, an information processing device serving as the tactile data creation device 2 includes a user interface processing unit (the UI processing unit 80) that performs user interface processing for creating data for tactile presentation, the user interface processing including processing of displaying a first display area (the coordinate area 146) on which a first operation of specifying time-series information about the data for tactile presentation is allowed; detecting the first operation; displaying a second display area (the time-series data display area 178) in which the time-series information specified according to the first operation is displayed; and detecting a change operation for the time-series information as a second operation on the second display area.

This makes it possible to create time-series information about tactile data and to visually confirm the time-series information.

Therefore, it is possible to reduce the burden on the operator for a creation operation on the tactile data and thus to easily create the tactile data.

As described with reference to FIGS. 24 and 25, the first operation may be an operation of specifying time-series information of a presentation target position (the position of the presentation target position pointer 153) of the tactile presentation.

This makes it possible to create the time-series information about the presentation target position of a tactile stimulus according to the tactile data. Therefore, it is possible to easily create tactile data in which the presentation target position changes with time.

As described with reference to FIGS. 24 and 25, the time-series information of the presentation target position may be specified by moving a pointer (mouse pointer) on the first display area (the coordinate area 146).

This makes it possible to easily specify the presentation target position of a tactile stimulus according to the tactile data by using a pointer device such as a mouse.

Therefore, it is possible to perform a creation operation on the tactile data efficiently and thus to reduce the burden on the operator.

As described with reference to FIGS. 22 to 28, the first operation may allow for specifying a presentation period (vibration period) in which the tactile presentation is to be performed and a non-presentation period (non-vibration period) in which the tactile presentation is not to be performed.

This makes it possible to create intermittent tactile data.

Therefore, it is possible to create various tactile data and thus to improve convenience.

As described with reference to FIG. 8 and others, the user interface processing unit (the UI processing unit 80) may perform processing of displaying position information of a presentation device (the presentation unit 8 or 45) that performs the tactile presentation in the first display area (the coordinate area 146). This makes it possible to create tactile data based on the position of the presentation device.

Therefore, the tactile data can be created while envisaging the stimulus experienced by the user by the tactile data, which facilitates to perform the creation operation on the tactile data.

As described with reference to FIG. 8 and others, the user interface processing unit (the UI processing unit 80) may display an operating range (the non-attenuation region 154 and the attenuation region 155) centered around the presentation target position in the first display area (the coordinate area 146). This makes it possible to create tactile data while being aware of not only the position of the presentation device (the presentation unit 8 or 45) but also the operating range according to the tactile data.

Therefore, it is possible to create the tactile data closer to the envision and thus to easily perform the creation operation on the tactile data.

As described with reference to FIGS. 29 and 30 and others, the user interface processing unit (the UI processing unit 80) may perform display processing of displaying a preview of the data for the tactile presentation in the first display area (the coordinate area 146).

This makes it possible to visually confirm the created tactile data. Therefore, it is possible to easily determine whether or not the tactile data is successfully created just as envisaged.

As described with reference to FIG. 8 and others, the user interface processing unit (the UI processing unit 80) may perform processing of detecting an operation of switching between a mode in which the change operation is enabled (for example, “WRITE” mode, “TOUCH” mode, or “LATCH” mode) and a mode in which the change operation is disabled (for example, “READ” mode). This makes it possible to confirm the created tactile data along the time axis and to perform a modification operation on the tactile data.

Therefore, it is possible to create the tactile data just as envisaged.

As described with reference to FIGS. 32 and 33, the second operation may be a change operation for time-series information of the presentation target position (the position of the presentation target position pointer 153).

This makes it possible to perform an operation of adjusting the presentation target position of a tactile stimulus according to the created tactile data. Therefore, when desired tactile data fails to be created, the desired tactile data can be easily created by modifying the already created tactile data without creating tactile data from scratch.

As described with reference to FIGS. 32 and 33, the second operation may be a change operation for time-series information of the operating range (for example, an operation of changing the size of the radius R).

This makes it possible to change to a wide range or a narrow range a stimulus experienced by the user when the tactile data is reproduced.

As a result, it is possible to create various tactile data for the user to experience various types of stimuli.

As described with reference to FIGS. 22 to 28 and others, the user interface processing unit (the UI processing unit 80) may display the second display area (the time-series data display area 178) so that the presentation period (vibration period) and the non-presentation period (non-vibration period) are distinguishable from each other.

This makes it possible to specifically grasp in time series the presence or absence of a stimulus experienced by the user when the tactile data is reproduced. Therefore, it is possible to appropriately create the tactile data according to the intention.

As described with reference to FIGS. 22 to 28 and others, the user interface processing unit (the UI processing unit 80) may display a presentation intensity of the tactile presentation (the output intensity of the presentation unit 8 or 45) in the second display area (the time-series data display area 178). For example, the presentation intensity of the tactile presentation is expressed by the height of the note-on region 193.

This makes it possible to change the intensity of a stimulus experienced by the user when the tactile data is reproduced.

Therefore, it is possible to appropriately create various tactile data.

As described with reference to FIG. 26 and others, the user interface processing unit (the UI processing unit 80) may display an operation pattern (tactile library) of a presentation device for each presentation period (vibration period) in the second display area (the time-series data display area 178).

This makes it possible to grasp what kind of operation pattern is executed in the presentation device (the presentation unit 8 or 45) during the presentation period.

Therefore, it is possible to assist in the creation of tactile data according to the envision.

As described with reference to FIG. 34, the second operation may be a change operation for a vibration pattern (tactile library).

This makes it possible to change, for example, a vibration pattern as an operation pattern of the presentation device (the presentation unit 8 or 45) for each presentation period (vibration period).

Therefore, it becomes easy to create various tactile data.

As described with reference to FIG. 36 and others, the second operation may be an operation of moving the time-series information to be changed in time direction. This makes it possible to modify, when the start timing of a presentation period (vibration period) of tactile data deviates from video and sound, the tactile data without recreating the tactile data.

Therefore, it is possible to appropriately create the intended tactile data with a reduced workload on the operator.

An information processing method performed by an information processing device serving as the tactile data creation device 2 includes processing of: displaying a first display area (the coordinate area 146) on which a first operation of specifying time-series information about the tactile data is allowed; detecting the first operation; displaying a second display area (the time-series data display area 178) in which the time-series information specified according to the first operation is displayed; and

detecting a change operation for the time-series information as a second operation on the second display area.

Note that the advantageous effects described in the present specification are merely exemplary and are not limited, and other advantageous effects may be obtained.

In addition, the above-mentioned examples can be combined in any way as long as the combination is not impossible.

### 7. Present Technology

(1) An information processing device including a user interface processing unit that performs user interface processing for creating data for tactile presentation, the user interface processing including:

displaying a first display area on which a first operation of specifying time-series information about the data is allowed;

detecting the first operation;

displaying a second display area in which the time-series information specified according to the first operation is displayed; and

detecting a change operation for the time-series information as a second operation on the second display area.

(2) The information processing device according to (1), wherein the first operation is an operation of specifying time-series information of a presentation target position of the tactile presentation.

(3) The information processing device according to (2), wherein the time-series information of the presentation target position is specified by moving a pointer on the first display area.

(4) The information processing device according to any one of (1) to (3), wherein the first operation allows for specifying a presentation period in which the tactile presentation is to be performed and a non-presentation period in which the tactile presentation is not to be performed.

(5) The information processing device according to any one of (1) to (4), wherein the user interface processing unit performs processing of displaying position information of a presentation device that performs the tactile presentation in the first display area.

(6) The information processing device according to (2), wherein the user interface processing unit displays an operating range centered around the presentation target position in the first display area.

(7) The information processing device according to any one of (1) to (6), wherein the user interface processing unit performs display processing of displaying a preview of the data in the first display area.

(8) The information processing device according to any one of (1) to (7), wherein the user interface processing unit performs processing of detecting an operation of switching between a mode in which the change operation is enabled and a mode in which the change operation is disabled.

(9) The information processing device according to (2), wherein the second operation is a change operation for time-series information of the presentation target position.

(10) The information processing device according to (6), wherein the second operation is a change operation for time-series information of the operating range.

(11) The information processing device according to (4), wherein the user interface processing unit displays the second display area so that the presentation period and the non-presentation period are distinguishable from each other.

(12) The information processing device according to any one of (1) to (11), wherein the user interface processing unit displays a presentation intensity of the tactile presentation in the second display area.

(13) The information processing device according to (4), wherein the user interface processing unit displays an operation pattern of a presentation device for each presentation period in the second display area.

(14) The information processing device according to (13), wherein the second operation is a change operation for the operation pattern.

(15) The information processing device according to any one of (1) to (14), wherein the second operation is an operation of moving the time-series information to be changed in time direction.

(16) An information processing method performed by an information processing device, the information processing method including:

displaying a first display area on which a first operation of specifying time-series information of data created for tactile presentation is allowed;

detecting the first operation;

displaying a second display area in which the time-series information specified according to the first operation is displayed; and

detecting a change operation for the time-series information as a second operation on the second display area.

### REFERENCE SIGNS LIST

2 Tactile data creation device
8, 45 Presentation unit (presentation device)
80 UI processing unit
146 Coordinate area (first display area)
178 Time-series data display area (second display area)
193 Note-on region (presentation period)

1. An information processing device comprising a user interface processing unit that performs user interface processing for creating data for tactile presentation, the user interface processing including:
displaying a first display area on which a first operation of specifying time-series information about the data is allowed;
detecting the first operation;
displaying a second display area in which the time-series information specified according to the first operation is displayed; and
detecting a change operation for the time-series information as a second operation on the second display area.

2. The information processing device according to claim 1, wherein the first operation is an operation of specifying time-series information of a presentation target position of the tactile presentation.

3. The information processing device according to claim 2, wherein the time-series information of the presentation target position is specified by moving a pointer on the first display area.

4. The information processing device according to claim 1, wherein the first operation allows for specifying a presentation period in which the tactile presentation is to be performed and a non-presentation period in which the tactile presentation is not to be performed.

5. The information processing device according to claim 1, wherein the user interface processing unit performs processing of displaying position information of a presentation device that performs the tactile presentation in the first display area.

6. The information processing device according to claim 2, wherein the user interface processing unit displays an operating range centered around the presentation target position in the first display area.

7. The information processing device according to claim 1, wherein the user interface processing unit performs display processing of displaying a preview of the data in the first display area.

8. The information processing device according to claim 1, wherein the user interface processing unit performs processing of detecting an operation of switching between a mode in which the change operation is enabled and a mode in which the change operation is disabled.

9. The information processing device according to claim 2, wherein the second operation is a change operation for time-series information of the presentation target position.

10. The information processing device according to claim 6, wherein the second operation is a change operation for time-series information of the operating range.

11. The information processing device according to claim 4, wherein the user interface processing unit displays the second display area so that the presentation period and the non-presentation period are distinguishable from each other.

12. The information processing device according to claim 1, wherein the user interface processing unit displays a presentation intensity of the tactile presentation in the second display area.

13. The information processing device according to claim 4, wherein the user interface processing unit displays an operation pattern of a presentation device for each presentation period in the second display area.

14. The information processing device according to claim 13, wherein the second operation is a change operation for the operation pattern.

15. The information processing device according to claim 1, wherein the second operation is an operation of moving the time-series information to be changed in time direction.

16. An information processing method performed by an information processing device, the information processing method comprising:
displaying a first display area on which a first operation of specifying time-series information of data created for tactile presentation is allowed;
detecting the first operation;
displaying a second display area in which the time-series information specified according to the first operation is displayed; and
detecting a change operation for the time-series information as a second operation on the second display area.
